(19) United States
(12) Patent Application Publication
(10) Pub. No.: US 2024/0249423 A1
(43) Pub. Date: Jul. 25, 2024

(54) PROCESSING IMAGE DATA USING MULTI-POINT DEPTH SENSING SYSTEM INFORMATION

(71) Applicant: QUALCOMM Incorporated, San Diego, CA (US)

(72) Inventors: Wen-Chun FENG, New Taipei City (TW); Mian LI, Shenzhen (CN); Hui Shan KAO, New Taipei City (TW)

(21) Appl. No.: 18/561,271

(22) PCT Filed: Jul. 7, 2021
(86) PCT No.: PCT/CN2021/104992

§ 371 Date: Nov. 15, 2023

(51) Int. Cl. G06T 7/50; G06T 3/40; G06T 7/62; G06V 10/25; H04N 9/73

(52) U.S. Cl. CPC G06T 7/50; G06T 3/40; G06T 7/62; G06V 10/25; H04N 9/73; G06V 2201/07

(57) ABSTRACT

Systems and techniques are provided for processing one or more images. For instance, aspects include a process that can include determining a first region of interest corresponding to a first object depicted in an image obtained using at least one camera. The first region of interest is associated with at least one element of a multi-point grid associated with a multi-point depth sensing system. The process can include determining a first extended region of interest for the first object. The first extended region of interest is associated with a plurality of elements including the at least one element and one or more additional elements of the multi-point grid. The process can further include, based on the plurality of elements associated with the first extended region of interest, determining representative depth information representing a first distance between the at least one camera and the first object depicted in the image.

### FIELD

This application is related to image processing. In some examples, aspects of the application relate to processing image data using information from a multi-point depth sensing system.

### BACKGROUND

Cameras can be configured with a variety of image capture and image processing settings to alter the appearance of an image. Some image processing operations are determined and applied before or during capture of the photograph, such as auto-focus, auto-exposure, and auto-white-balance operations, among others. These operations are configured to correct and/or alter one or more regions of an image (for example, to ensure the content of the regions is not blurry, over-exposed, or out-of-focus). The operations may be performed automatically by an image processing system or in response to user input.

### SUMMARY

Systems and techniques are described herein for processing image data (e.g., using automatic-focus, automatic-exposure, automatic-white-balance, automatic-zoom, and/or other operations) using information from a multi-point depth sensing system. According to at least one example, a method of processing image data is provided. The method can include: determining a first region of interest corresponding to a first object depicted in an image obtained using at least one camera, the first region of interest being associated with at least one element of a multi-point grid associated with a multi-point depth sensing system: determining a first extended region of interest for the first object, the first extended region of interest being associated with a plurality of elements including the at least one element and one or more additional elements of the multi-point grid: and based on the plurality of elements associated with the first extended region of interest, determining representative depth information representing a first distance between the at least one camera and the first object depicted in the image.

In another example, an apparatus for processing image data is provided. The apparatus can include at least one memory and one or more processors (e.g., implemented in circuitry) coupled to the at least one memory. The one or more processors are configured to: determine a first region of interest corresponding to a first object depicted in an image obtained using at least one camera, the first region of interest being associated with at least one element of a multi-point grid associated with a multi-point depth sensing system: determine a first extended region of interest for the first object, the first extended region of interest being associated with a plurality of elements including the at least one element and one or more additional elements of the multi-point grid: and based on the plurality of elements associated with the first extended region of interest, determine representative depth information representing a first distance between the at least one camera and the first object depicted in the image.

In another example, a non-transitory computer-readable medium is provided that has stored thereon instructions that, when executed by one or more processors, cause the one or more processors to: determine a first region of interest corresponding to a first object depicted in an image obtained using at least one camera, the first region of interest being associated with at least one element of a multi-point grid associated with a multi-point depth sensing system; determine a first extended region of interest for the first object, the first extended region of interest being associated with a plurality of elements including the at least one element and one or more additional elements of the multi-point grid: and based on the plurality of elements associated with the first extended region of interest, determine representative depth information representing a first distance between the at least one camera and the first object depicted in the image.

In another example, an apparatus for processing image data is provided. The apparatus includes: means for determining a first region of interest corresponding to a first object depicted in an image obtained using at least one camera, the first region of interest being associated with at least one element of a multi-point grid associated with a multi-point depth sensing system: means for determining a first extended region of interest for the first object, the first extended region of interest being associated with a plurality of elements including the at least one element and one or more additional elements of the multi-point grid: and means for determining, based on the plurality of elements associated with the first extended region of interest, representative depth information representing a first distance between the at least one camera and the first object depicted in the image.

In some aspects, the method, apparatuses, and computer-readable medium described above can include: processing the image based on the representative depth information representing the first distance, wherein processing the image includes performing at least one of automatic-exposure, automatic-focus, automatic-white-balance, and automatic-zoom on at least the first region of interest of the image.

In some aspects, to determine the first extended region of interest for the first object, the method, apparatuses, and computer-readable medium described above can include: determining at least one of a size of the first region of interest and a location of the first region of interest relative to a reference point in the image; and determining the first extended region of interest for the first object based on at least one of the size and the location of the first region of interest.

In some aspects, to determine the first extended region of interest for the first object, the method, apparatuses, and computer-readable medium described above can include: determining the first extended region of interest for the first object based on the size of the first region of interest.

In some aspects, to determine the first extended region of interest for the first object, the method, apparatuses, and computer-readable medium described above can include determining the first extended region of interest for the first object based on the location of the first region of interest.

In some aspects, to determine the first extended region of interest for the first object, the method, apparatuses, and computer-readable medium described above can include: determining the first extended region of interest for the first object based on the size and the location of the first region of interest.

In some aspects, to determine the first extended region of interest for the first object, the method, apparatuses, and computer-readable medium described above can include: determining a first depth associated with a first element of the one or more additional elements of the multi-point grid, the first element neighboring the at least one element associated with the first region of interest: determining a difference between the first depth and a depth of the at least one element associated with the first region of interest is less than a threshold difference; and associating the first element with the first extended region of interest based on determining the difference between the first depth and the depth of the at least one element associated with the first region of interest is less than the threshold difference.

In some aspects, the method, apparatuses, and computer-readable medium described above can associate the first element with the first extended region of interest further based on a confidence of the first depth being greater than a confidence threshold.

In some aspects, the method, apparatuses, and computer-readable medium described above can include: determining a second depth associated with a second element of the one or more additional elements of the multi-point grid, the second element neighboring the first element of the one or more additional elements: determining a difference between the second depth and the first depth is less than the threshold difference: and associating the second element with the first extended region of interest based on determining the difference between the second depth and the first depth is less than the threshold difference.

In some aspects, the method, apparatuses, and computer-readable medium described above can include: determining a second depth associated with a second element of the one or more additional elements of the multi-point grid, the second element neighboring the first element of the one or more additional elements: determining the difference between the second depth and the first depth is greater than the threshold difference: and excluding the second element from the first extended region of interest based on determining the difference between the second depth and the first depth is greater than the threshold difference.

In some aspects, to determine the representative depth information representing the first distance, the method, apparatuses, and computer-readable medium described above can include: determining a representative depth value for the first extended region of interest based on depth values of the plurality of elements associated with the first extended region of interest.

In some aspects, the representative depth value includes an average of the depth values of the plurality of elements associated with the first extended region of interest.

In some aspects, the method, apparatuses, and computer-readable medium described above can include: based on the first region of interest being the only region of interest determined for the image, processing the image based on the representative depth information representing the first distance.

In some aspects, to process the image based on the representative depth information representing the first distance, the method, apparatuses, and computer-readable medium described above can include performing at least one of automatic-exposure, automatic-focus, automatic-white-balance, and automatic-zoom on at least the first region of interest of the image.

In some aspects, the method, apparatuses, and computer-readable medium described above can include: determining a second region of interest corresponding to a second object depicted in the image, the second region of interest being associated with at least one additional element of the multi-point grid associated with the multi-point depth sensing system; determining a second extended region of interest for the second object, the second extended region of interest being associated with a plurality of elements including the at least one additional element and second one or more additional elements of the multi-point grid: and based on the plurality of elements associated with the second extended region of interest, determining representative depth information representing a second distance between the at least one camera and the second object depicted in the image.

In some aspects, the method, apparatuses, and computer-readable medium described above can include: determining combined depth information based on the representative depth information representing the first distance and the representative depth information representing the second distance.

In some aspects, to determine the combined depth information, the method, apparatuses, and computer-readable medium described above can include determining a weighted average of the representative depth information representing the first distance and the representative depth information representing the second distance.

In some aspects, the method, apparatuses, and computer-readable medium described above can include: processing the image based on the combined depth information.

In some aspects, to process the image based on the combined depth information, the method, apparatuses, and computer-readable medium described above can include performing at least one of automatic-exposure, automatic-focus, automatic-white-balance, and automatic-zoom on at least the first region of interest of the image.

In some aspects, the multi-point depth sensing system includes a transmitter including a plurality of light sources and a receiver configured to receive reflections of light emitted by the plurality of light sources. In some cases, the representative depth information is determined based on the received reflections of light.

According to at least one additional example, a method of processing image data is provided. The method can include: determining a region of interest corresponding to at least one object depicted in an image obtained using at least one camera, the region of interest being associated with a plurality of elements of a multi-point grid associated with a multi-point depth sensing system: determining whether the region of interest includes multi-depth information based on depth information associated with the plurality of elements: and based on whether the region of interest includes multi-depth information, determining representative depth information representing a distance between the at least one camera and the at least one object depicted in the image.

In another example, an apparatus for processing image data is provided. The apparatus can include at least one memory and one or more processors (e.g., implemented in circuitry) coupled to the at least one memory. The one or more processors are configured to: determine a region of interest corresponding to at least one object depicted in an image obtained using at least one camera, the region of interest being associated with a plurality of elements of a multi-point grid associated with a multi-point depth sensing system: determine whether the region of interest includes multi-depth information based on depth information associated with the plurality of elements: and based on whether the region of interest includes multi-depth information, determine representative depth information representing a distance between the at least one camera and the at least one object depicted in the image.

In another example, a non-transitory computer-readable medium is provided that has stored thereon instructions that, when executed by one or more processors, cause the one or more processors to: determine a region of interest corresponding to at least one object depicted in an image obtained using at least one camera, the region of interest being associated with a plurality of elements of a multi-point grid associated with a multi-point depth sensing system; determine whether the region of interest includes multi-depth information based on depth information associated with the plurality of elements: and based on whether the region of interest includes multi-depth information, determine representative depth information representing a distance between the at least one camera and the at least one object depicted in the image.

In another example, an apparatus for processing image data is provided. The apparatus includes: means for determining a region of interest corresponding to at least one object depicted in an image obtained using at least one camera, the region of interest being associated with a plurality of elements of a multi-point grid associated with a multi-point depth sensing system: means for determining whether the region of interest includes multi-depth information based on depth information associated with the plurality of elements: and means for determining, based on whether the region of interest includes multi-depth information, representative depth information representing a distance between the at least one camera and the at least one object depicted in the image.

In some aspects, the method, apparatuses, and computer-readable medium described above can include: sorting the plurality of elements according to the representative depth information associated with the plurality of elements, wherein the plurality of elements are sorted from smallest depth to largest depth.

In some aspects, to determine whether the region of interest includes the multi-depth information, the method, apparatuses, and computer-readable medium described above can include: determining a difference between a smallest depth value of the plurality of elements and a largest depth value of the plurality of elements is greater than a multi-depth threshold; and determining the region of interest includes multi-depth information based on determining the difference between the smallest depth value and the largest depth value is greater than the multi-depth threshold.

In some aspects, to determine the representative depth information, the method, apparatuses, and computer-readable medium described above can include: selecting a second or third smallest depth value as the representative depth information.

In some aspects, to determine whether the region of interest includes the multi-depth information, the method, apparatuses, and computer-readable medium described above can include: determining a difference between a smallest depth value of the plurality of elements and a largest depth value of the plurality of elements is less than a multi-depth threshold: and determining the region of interest does not include multi-depth information based on determining the difference between the smallest depth value and the largest depth value is less than the multi-depth threshold.

In some aspects, to determine the representative depth information, the method, apparatuses, and computer-readable medium described above can include: determining a depth value associated with a majority of elements from the plurality of elements of the multi-point grid: and selecting the depth value as the representative depth information.

In some aspects, the method, apparatuses, and computer-readable medium described above can include: processing the image based on the representative depth information representing the distance, wherein processing the image includes performing at least one of automatic-exposure, automatic-focus, automatic-white-balance, and automatic-zoom on at least the region of interest of the image.

In some aspects, the multi-point depth sensing system includes a transmitter including a plurality of light sources and a receiver configured to receive reflections of light emitted by the plurality of light sources. In some cases, the representative depth information is determined based on the received reflections of light.

In some aspects, one or more of the apparatuses described above is or is part of a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a vehicle (e.g., a computing device of a vehicle), or other device. In some aspects, an apparatus includes a camera or multiple cameras for capturing one or more images. In some aspects, the apparatus further includes a display for displaying one or more images, notifications, and/or other displayable data. In some aspects, the apparatus can include one or more sensors, which can be used for determining a location and/or pose of the apparatus, a state of the apparatuses, and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a block diagram illustrating an example architecture of an image capture and processing system, in accordance with some examples:

FIG. 2A and FIG. 2B are illustrations of performing an image capture operation, in accordance with some examples:

FIG. 3 is a diagram illustrating an example of a time-of-flight (TOF) system, in accordance with some examples:

FIG. 4A is an image illustrating a field of view (FOV) of a single point light source of a depth sensing system, in accordance with some examples:

FIG. 4B is an image illustrating a 4×4 grid associated with a depth sensing system having a multi-point light source, in accordance with some examples:

FIG. 5 is a diagram illustrating an example of a structured light system, in accordance with some examples:

FIG. 6A is a diagram illustrating flow diagram illustrating an example of a process that applies image processing algorithm(s) using multi-point depth information and region of interest (ROI) information, in accordance with some examples:

FIG. 6B is a diagram illustrating an example of a multi-point depth sensing controller that can perform one or more image capture and processing operations, in accordance with some examples:

FIG. 7A is a diagram illustrating is an image illustrating an example of a grid of a multi-point light source, in accordance with some examples:

FIG. 7B is a diagram illustrating another example of a grid of a multi-point light source, in accordance with some examples:

FIG. 8A is an image illustrating an extended ROI that includes a size that is two times the size of an original or target ROI, in accordance with some examples:

FIG. 8B is an image illustrating an extended ROI that includes a size that is four times the size of an original or target ROI, in accordance with some examples:

FIG. 9 is a diagram illustrating an example of extending a target ROI based on a coordinate correlation of a multi-point grid near the target ROI, in accordance with some examples:

FIG. 10 is a flow diagram illustrating an example of a process that can be performed by a data analyzer of the multi-point depth sensing controller of FIG. 6, in accordance with some examples:

FIG. 11 includes images overlaid with a multi-point grid showing operations of a multi-subject optimizer of the multi-point depth sensing controller of FIG. 6, in accordance with some examples:

FIG. 12 is an image including multiple subjects at different depths, in accordance with some examples:

FIG. 13 is a flow diagram illustrating an example of a process for processing image data, in accordance with some examples:

FIG. 14 is a flow diagram illustrating an example of a process for processing image data, in accordance with some examples: and

FIG. 15 is a diagram illustrating an example of a system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras can be configured with a variety of image capture and/or image processing operations and settings. The different settings result in images with different appearances.

Some camera operations are determined and applied before or during capture of the photograph, such as automatic-focus (also referred to as auto-focus), automatic-exposure (also referred to as auto-exposure), and automatic white-balance algorithms (also referred to as auto-while-balance), collectively referred to as “3A” or the “3As”. Additional camera operations applied before, during, or after capture of an image include operations involving zoom (e.g., zooming in or out), ISO, aperture size, f/stop, shutter speed, and gain. Other camera operations can configure post-processing of an image, such as alterations to contrast, brightness, saturation, sharpness, levels, curves, or colors.

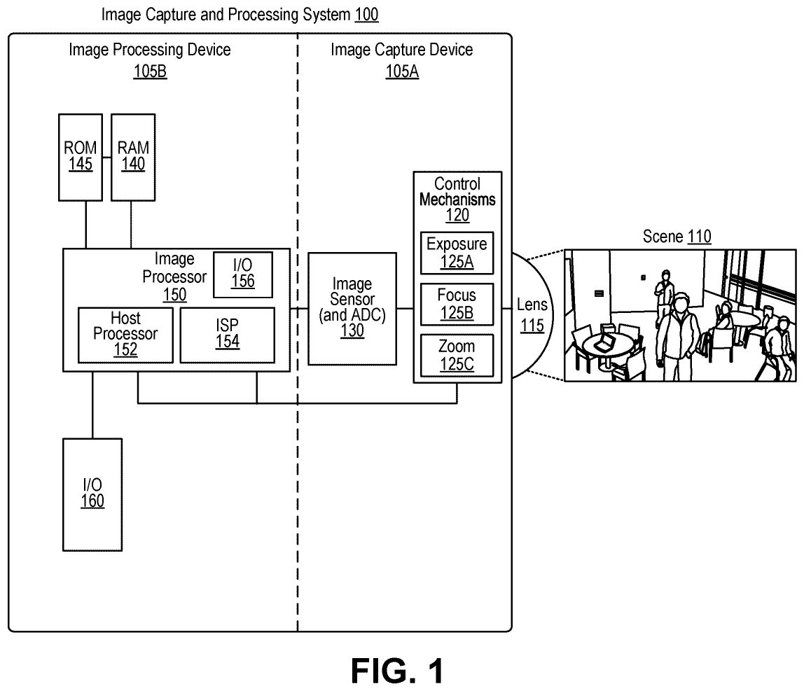

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components: for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties. In some cases, the one or more control mechanisms 120 may control and/or implement “3A” image processing operations.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the device 105A, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1510 discussed with respect to the computing system 1500. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1520, read-only memory (ROM) 145/1525, a cache 1512, a memory unit 1515, another storage device 1530, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1535, any other input devices 1545, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the device 105B and one or more peripheral devices, over which the device 105B may receive data from the one or more peripheral device and/or transmit data to the one or more peripheral devices. The I/O 160 may include one or more wireless transceivers that enable a wireless connection between the device 105B and one or more peripheral devices, over which the device 105B may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames. The host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. The settings of different modules of the ISP 154 can be configured by the host processor 152. Each module may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image capture and processing system 100 may perform one or more of the image processing functionalities described above automatically. For instance, one or more of the control mechanisms 120 may be configured to perform auto-focus operations, auto-exposure operations, and/or auto-white-balance operations (referred to as the “3As,” as noted above). In some embodiments, an auto-focus functionality allows the image capture device 105A to focus automatically prior to capturing the desired image. Various auto-focus technologies exist. For instance, active autofocus technologies determine a range between a camera and a subject of the image via a range sensor of the camera, typically by emitting infrared lasers or ultrasound signals and receiving reflections of those signals. In addition, passive auto-focus technologies use a camera's own image sensor to focus the camera, and thus do not require additional sensors to be integrated into the camera. Passive AF techniques include Contrast Detection Auto Focus (CDAF), Phase Detection Auto Focus (PDAF), and in some cases hybrid systems that use both. The image capture and processing system 100 may be equipped with these or any additional type of auto-focus technology.

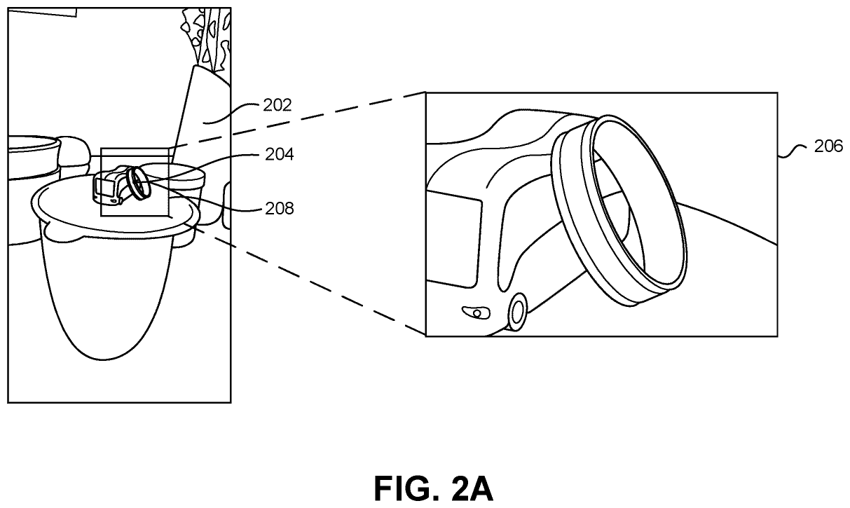

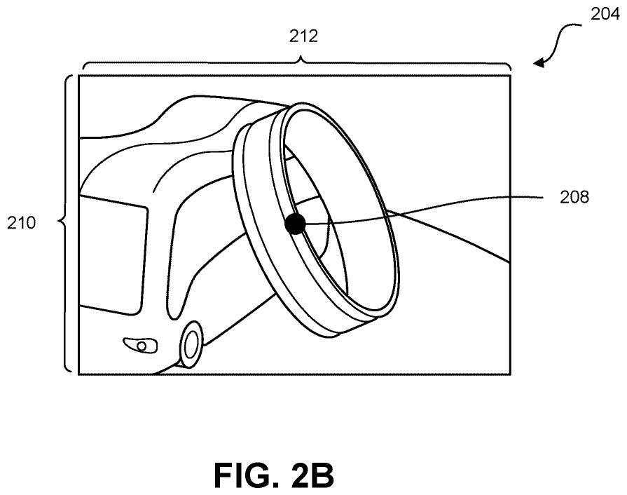

FIG. 2A and FIG. 2B illustrate an example of images that may be captured and/or processed while the image capture and processing system 100 performs an auto-focus operation or other “3A” operation. Specifically, FIG. 2A and FIG. 2B illustrate an example of an auto-focus operation that utilizes a fixed region of interest (ROI). As illustrated in FIG. 2A, the image capture device 105A of the system 100 may capture an image frame 202. In some cases, the image processing device 105B may detect that the user has selected a location 208 within the image frame 202 (e.g., while the image frame 202 is displayed within a preview stream). For instance, the image processing device 105B may determine that the user has provided input (e.g., using a finger, a gesture, a stylus, and/or other suitable input mechanism) that includes selection of a pixel or group of pixels corresponding to the location 208. In some cases, the image processing device 105B or other component or system may perform object detection to detect an object at the location 208 (e.g., the ring depicted in FIG. 2A). The image processing device 105B may then determine an ROI 204 that includes the location 208. Image processor 150 may perform an auto-focus operation, another “3A” operation (e.g., auto-exposure or auto-white-balance) or other operation (e.g., auto-zoom, etc.) on image data within the ROI 204. The result of the auto-focus operation is illustrated in image frame portion 206 shown in FIG. 2A

FIG. 2B illustrates an illustrative example of the ROI 204. In the example of FIG. 2B, the image processing device 105B may determine and/or generate the ROI 204 by centering the location 208 within a region of the image frame 202 whose dimensions are defined by a predetermined width 212 and a predetermined height 210. In some cases, the predetermined width 212 and the predetermined height 210 may correspond to a preselected number of pixels (such as 10 pixels, 50 pixels, 100 pixels, etc.). Additionally or alternatively, the predetermined width 212 and the predetermined height 210 may correspond to preselected distances (such as 0.5 centimeters, 1 centimeter, 2 centimeters, etc.) within a display that displays the image frame 202 to a user. While FIG. 2B illustrates the ROI 204 as a rectangle, the ROI 204 may be of any alternative shape, including a square, a circle, an oval, among others.

In some cases, the image processing device 105B may determine pixels corresponding to the boundaries of the ROI 204 by accessing and/or analyzing information indicating coordinates of pixels within the image frame 202. As an illustrative example, the location 208 selected by the user may correspond to a pixel with an x-axis coordinate (in a horizontal direction) of 200 and a y-axis coordinate (in a vertical direction) of 300 within the image frame 202. If the image processing device 105B is configured to generate fixed ROIs whose height is 100 pixels and whose length is 200 pixels, the image processing device 105B may define the ROI 204 as a box with corners corresponding to the coordinates (150, 400), (250, 400), (150, 200), and (250, 200). The image processing device 105B may utilize any additional or alternative technique to generate ROIs.

In many camera systems, image capture and/or processing operations (e.g., auto-focus, auto-exposure, auto-while-balance, auto-zoom, and/or other operations) can utilize information from a depth sensing system. In one illustrative example, a camera system can utilize information from a depth sensing system that includes a single point light source (e.g., laser) to assist with auto-focus operations in low light conditions (e.g., lighting conditions with a lux value of 20 or less). For instance, in low light conditions, camera system configured to perform PDAF may not be able to perform auto-focus due to the lack of image information obtained by the image sensor. The depth sensing system can provide depth information for use in performing the auto-focus operations. An example of a depth sensing system using a single point light source can include a time-of-flight (TOF) based depth sensing system.

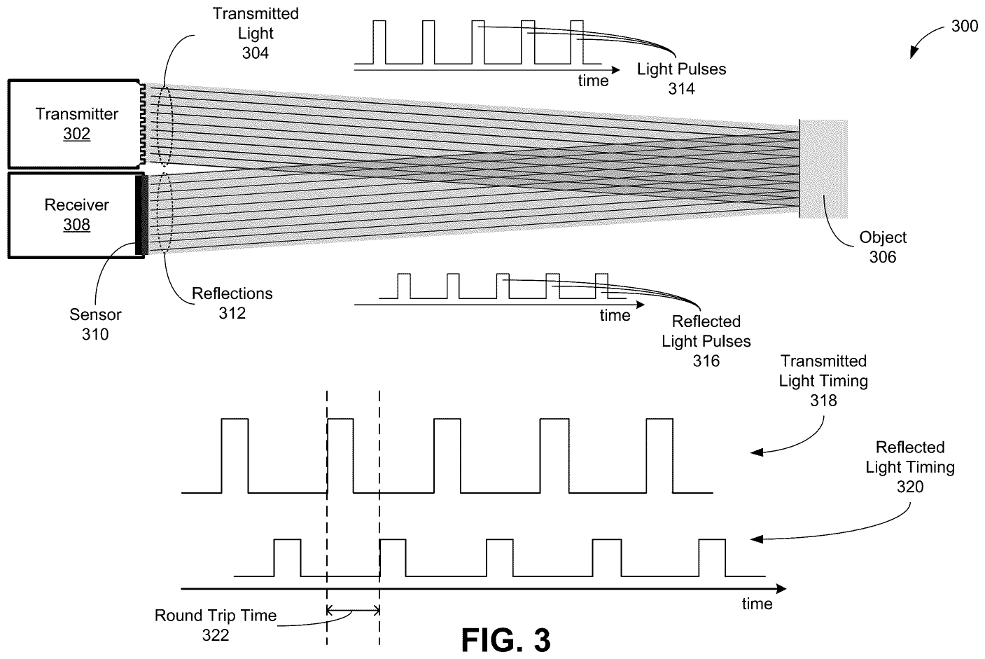

FIG. 3 is a diagram illustrating an example of a TOF system 300. The TOF system 300 may be used to generate a depth map (not shown) of a scene or a portion of the scene (e.g., of an object in the scene that reflects light emitted into the scene) or may be used for other applications for ranging. The TOF system 300 may include a transmitter 302 and a receiver 308. The transmitter 302 may be referred to as a “transmitter,” “projector,” “emitter,” and so on, and should not be limited to a specific transmission component. Similarly, the receiver 308 may be referred to as a “detector,” “sensor,” “sensing element,” “photodetector,” and so on, and should not be limited to a specific receiving component. In one illustrative example, the TOF system 300 can be used to generate a depth map of an object 306 in the scene. As shown in FIG. 3, the object 306 is illustrated as reflecting light emitted by the transmitter 302 of the TOF system 300, which is then received by the receiver 308 of the TOF system 300. The light emitted by the transmitter 302 is shown as transmitted light 304. The light that is reflected by the object 306 is shown as reflections 312.

The transmitter 302 may be configured to transmit, emit, or project signals (such as light or a field of light) onto the scene. In some cases, the transmitter 302 can transmit light (e.g., transmitted light 304) in the direction of the object 306. While the transmitted light 304 is illustrated only as being directed toward the object 306, the field of the emission or transmission by the transmitter 302 may extend beyond the object 306 (e.g., toward the entire scene including the object 306). For example, a conventional TOF system transmitter can include a fixed focal length lens for the emission that defines the field of the emission traveling away from the transmitter.

The transmitted light 304 includes light pulses 314 at known time intervals (such as periodically). The receiver 308 includes a sensor 310 that is configured to sense the reflections 312 of the transmitted light 304. The reflections 312 include the reflected light pulses 316. The TOF system 300 can determine a round trip time 322 for the light by comparing the timing 318 of the transmitted light pulses to the timing 320 of the reflected light pulses. The distance of the object 306 from the TOF system may be calculated to be half the round trip time multiplied by the speed of the emissions (e.g., the speed of light for light emissions).

The sensor 310 may include an array of photodiodes to measure or sense the reflections. Alternatively, the sensor 310 may include a complementary metal-oxide-semiconductor (CMOS) sensor or other suitable photo-sensitive sensor including a number of pixels (or photo-diodes) or regions for sensing. In some cases, the TOF system 300 can identify the reflected light pulses 316 as sensed by the sensor 310 when the magnitude of the pulses is greater than a threshold. For example, the TOF system 300 can measure a magnitude of the ambient light and other interference without the signal. The TOF system 300 can then determines if further measurements are greater than the previous measurement by a measurement threshold. The upper limit of the effective range of a TOF system may be the distance where the noise or the degradation of the signal, before sensing the reflections, cause the signal-to-noise ratio (SNR) to be too great for the sensor to accurately sense the reflected light pulses 316. To reduce interference, the receiver 308 may include a bandpass filter before the sensor 310 to filter some of the incoming light at different wavelengths than the transmitted light 304.

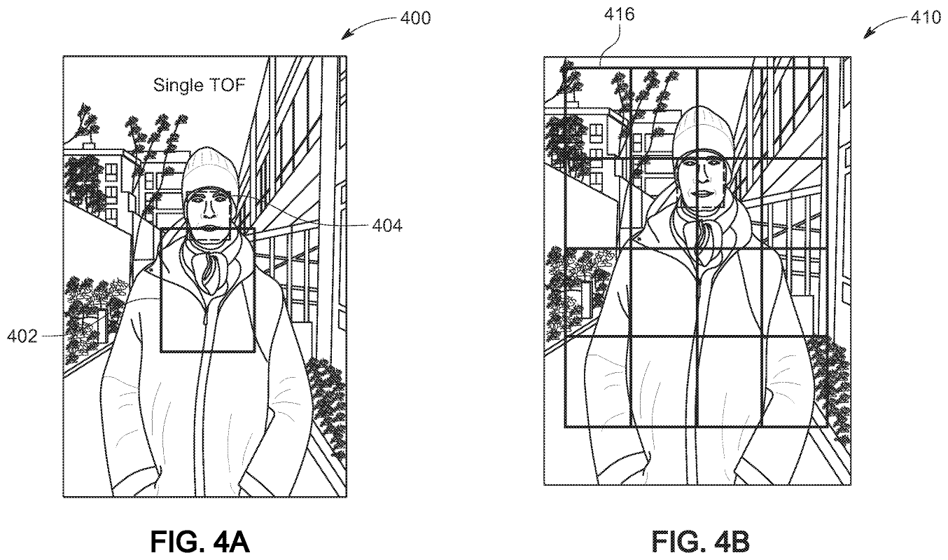

However, a single point light source can have a small field-of-view (FOV) coverage within an image. In one illustrative example, a single point light source can have a diagonal FOV (from a top-left corner to a bottom-right corner) of 25°. The single point light source is a hardware component (e.g., a laser) that is embedded into a device. The FOV of the single point light source is based on the position and orientation of the light source on or in the device in which it is embedded. FIG. 4A is an image 400 showing the FOV 402 of a single point light source of a depth sensing system. As shown, the FOV 402 is small relative to the size of the entire image 400. A ROI 404 is also illustrated in FIG. 4A. As described above with respect to FIG. 2A, the ROI 404 can be determined based on a user providing touch input relative to the face of person depicted in the image 400, based on face detection being used to detect the face of the person, and/or using other information. As shown in FIG. 4A, the FOV 402 of the single-point light source of a depth sensing system covers the center of the image, making it difficult to perform image capture or processing operations (e.g., auto-focus, auto-exposure, auto-white-balance, etc.) on an off-center object. For instance, the FOV 402 does not cover the majority of the ROI 404. The single-point light source thus does not provide depth information corresponding to the face depicted in the image 400. As a result, image capture or processing operations (e.g., auto-focus, auto-exposure, etc.) may not be properly performed for the portion of the image within the ROI 404. For instance, in low light conditions (e.g., a lux value of 20 or less), the information captured by the image sensor (e.g., by image pixels and PDAF pixels of the image sensor) may lack the texture for auto-focus to be properly performed on the ROI 404 of the image 400, and the depth information from the single-point light source may not provide the depth information for the ROI 404, in which case the depth information cannot be used to make up for the lack of image information.

Another problem with a single light source based depth sensing system is that it provides less options for image processing operations (e.g., auto-focus, etc.). For example, because the single light source only provides a single depth value per image (e.g., a single depth value for the FOV 402 shown in FIG. 4A), image processing operations cannot generate an output image for a multi-depth scene with different characteristics for the different depths depicted in the image (e.g., a first level of focus for an object at a first depth, a second level of focus for a second object at a second depth, and a third level of focus for the background).

In some cases, a depth sensing system can utilize a multi-point light source to determine depths within a scene. Examples of multi-point-based depth sensing systems include TOF systems with multiple light sources and structured light systems. In one illustrative example, a multi-point light source of a depth sensing system can include an emitter (or transmitter) having configured to transmit 940 nanometer (nm) infrared (IR) (or near-IR) light and a receiver including an array of single photo avalanche diodes (SPADS). The example multi-point light source can include a range of up to 400 centimeters (cm), a diagonal FOV of 61° (e.g., controlled by the design of the lens through which the light is emitted), a resolution (e.g., expressed as a number of zones) of 4×4 zones (e.g., at 60 frames per second (fps) maximum ranging frequency) or 8×8 zones (e.g., at 15 fps maximum ranging frequency), and a range accuracy of 15 millimeters (mm) at macro and 5% at other distances.

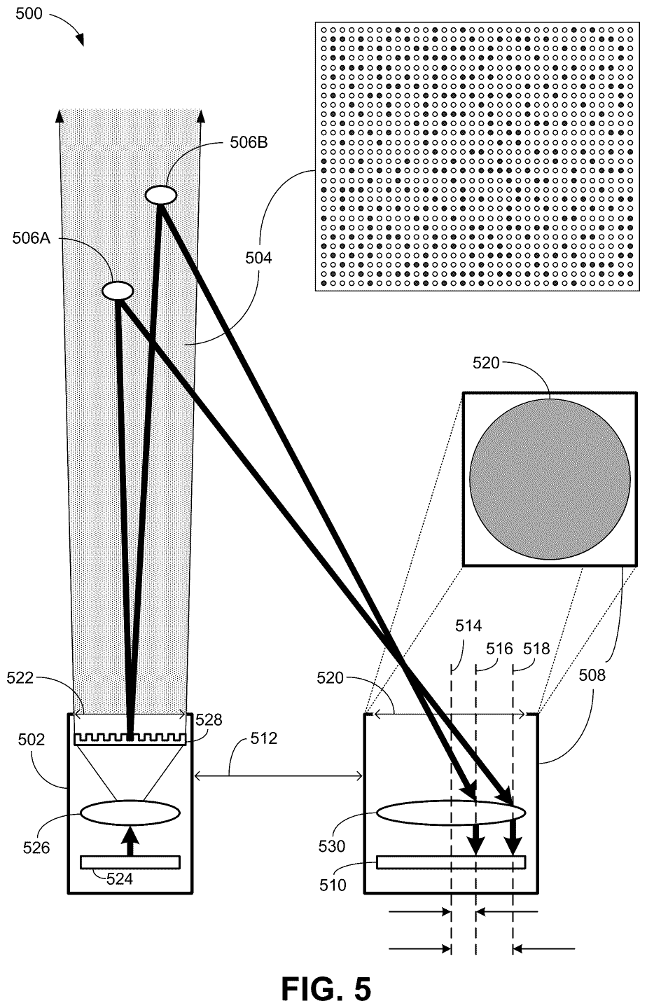

FIG. 5 is a depiction of a structured light system 500. The structured light system 500 may be used to generate a depth map (not pictured) of a scene (with objects 506A and 506B at different depths in the scene) or may be used for other applications for ranging of objects 506A and 506B or other portions of the scene. The structured light system 500 may include a transmitter 502 and a receiver 508.

The transmitter 502 may be configured to project a spatial pattern 504 onto the scene (including objects 506A and 506B). The transmitter 502 may include one or more light sources 524 (such as laser sources), a lens 526, and a light modulator 528. In some embodiments, the light modulator 528 includes one or more diffractive optical elements (DOEs) to diffract the emissions from one or more light sources 524 (which may be directed by the lens 526 to the light modulator 528) into additional emissions. The light modulator 528 may also adjust the intensity of the emissions. Additionally or alternatively, the lights sources 524 may be configured to adjust the intensity of the emissions.

In some other implementations of the transmitter 502, a DOE may be coupled directly to a light source (without lens 526) and be configured to diffuse the emitted light from the light source into at least a portion of the spatial pattern 504. The spatial pattern 504 may be a fixed pattern of emitted light that the transmitter projects onto a scene. For example, a DOE may be manufactured so that the black spots in the spatial pattern 504 correspond to locations in the DOE that prevent light from the light source 524 being emitted by the transmitter 502. In this manner, the spatial pattern 504 may be known in analyzing any reflections received by the receiver 508. The transmitter 502 may transmit the light in a spatial pattern through the aperture 522 of the transmitter 502 and onto the scene (including objects 506A and 506B).

The receiver 508 may include an aperture 520 through which reflections of the emitted light may pass, be directed by a lens 530 and hit a sensor 510. The sensor 510 may be configured to detect (or “sense”), from the scene, one or more reflections of the spatial patterned light. As illustrated, the transmitter 502 may be positioned on the same reference plane as the receiver 508, and the transmitter 502 and the receiver 508 may be separated by a distance called the “baseline” 512.

The sensor 510 may include an array of photodiodes (such as avalanche photodiodes) to measure or sense the reflections. The array may be coupled to a complementary metal-oxide semiconductor (CMOS) sensor including a number of pixels or regions corresponding to the number of photodiodes in the array. The plurality of electrical impulses generated by the array may trigger the corresponding pixels or regions of the CMOS sensor to provide measurements of the reflections sensed by the array. Alternatively, the sensor 510 may be a photosensitive CMOS sensor to sense or measure reflections including the reflected codeword pattern. The CMOS sensor logically may be divided into groups of pixels that correspond to a size of a bit or a size of a codeword (a patch of bits) of the spatial pattern 504.

The reflections may include multiple reflections of the spatial patterned light from different objects or portions of the scene at different depths (such as objects 506A and 506B). Based on the baseline 512, displacement and distortion of the sensed light in spatial pattern 504, and intensities of the reflections, the structured light system 500 may be used to determine one or more depths and locations of objects (such as objects 506A and 506B) from the structured light system 500. With triangulation based on the baseline and the distances, the structured light system 500 may be used to determine the differing distances between objects 506A and 506B. For example, a first distance between the center 514 and the location 516 where the light reflected from the object 506B hits the sensor 510 is less than a second distance between the center 514 and the location 518 where the light reflected from the object 506A hits the sensor 510. The distances from the center to the location 516 and the location 518 of the sensor 510 may indicate the depth of the objects 506A and 506B, respectively. The first distance being less than the second distance may indicate that the object 506B is further from the transmitter 502 than object 506A. In addition to determining a distance from the center of the sensor 510, the calculations may further include determining a displacement or distortion of the spatial pattern 504 in the light hitting the sensor 510 to determine depths or distances.

Thus, a multi-point light source provides an increased FOV and a greater amount of depth information as compared to a single-point light source. For example, FIG. 4B is an image 410 showing a 4×4 grid 416 (including 16 zones, also referred to as elements or cells). A depth sensing system including a multi-point light source can determine a depth value for each element or zone within the grid 416. For example, the grid 416 can correspond to a depth map including depth values for each element or zone within the grid. As compared to the FOV 402 of the single-point lighting system depicted in FIG. 4A, the FOV of the grid 416 is much larger. Further, the grid 416 includes 16 depth values per image (one for each element or zone within the grid 416), as compared to one depth value per image for the single-point light source.

Systems, apparatuses, processes (also referred to as methods), and computer-readable media (collectively referred to herein as “systems and techniques”) are described herein for processing image data (e.g., using auto-focus, auto-exposure, auto-white-balance, auto-zoom, and/or other operations) using information from a depth sensing system including a multi-point light source (e.g., multi-point laser or lasers).

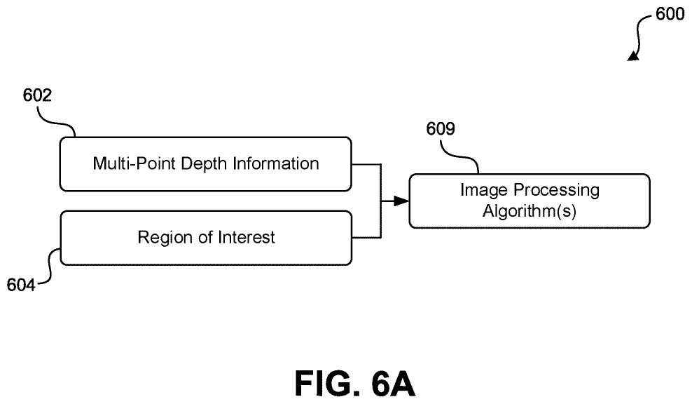

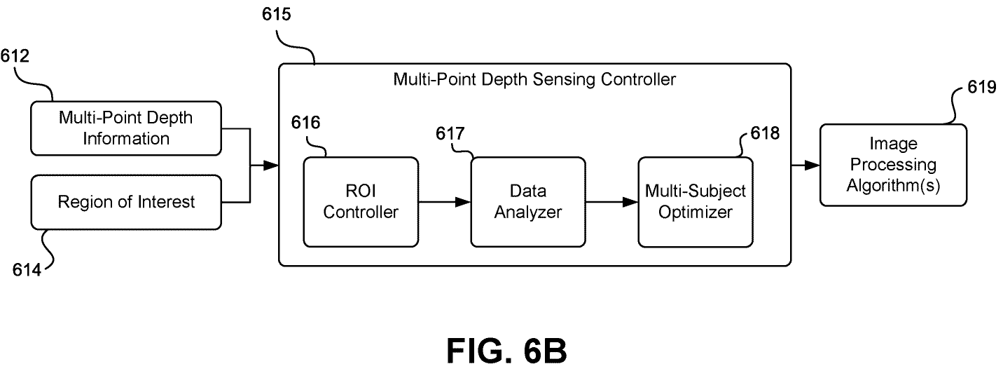

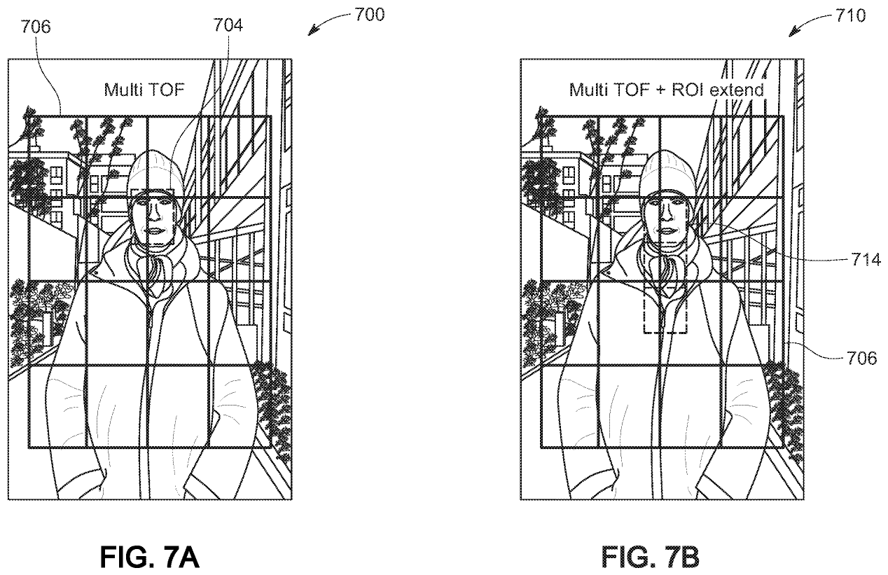

FIG. 6A is a flow diagram illustrating an example of a process 600 that applies image processing algorithm(s) 609 using multi-point depth information 602 and region of interest information 604. The image processing algorithm(s) 609 can include one or more auto-focus algorithms, one or more auto-exposure algorithms, one or more auto-white-balance algorithms, one or more auto-zoom algorithms, and/or other algorithms or operations. FIG. 7A is an image 700 illustrating grid 706 of a multi-point light source (corresponding to a FOV of the multi-point light source). Using depth information from the depth sensing system having the multi-point light source, the process 600 can obtain the distance or depth of an off-center object (an object displaced from the center of the image). For instance, as shown in FIG. 7A, an ROI 704 corresponds to a face of a person depicted in the image 700. Two elements (also referred to as zones or cells) of the grid 706 cover the majority of the ROI 704, and thus can provide depth values for the ROI 704. However, due to the small size of the face of the person, the distance or depth from the multi-point light source may not be not stable. For instance, depths of other objects (e.g., the building behind the person) that are within the elements (or zones or cells) of the grid 706 encompassing the face may introduce noise and thus the depth values of the grid elements may not accurately reflect the true depth or distance of the person from the multi-point light source.

Furthermore, using a multi-point light source, the process 600 and associated system can obtain the depth or distance for each grid element. Typically, such a process 600 and associated system uses the distance or depth having the majority of values in a multi-pint grid (e.g., the grid 416 shown in FIG. 4B) as the output. However, if the majority distance or depth corresponds to an object that is further away in a scene, the result may be deficient as a user may expect that, when there are objects at different depths within in the scene, the system will focus on the object that is closest to the camera. Even further, while the process 600 and associated system can obtain the distance or depth for each grid element, only one distance can be selected as output for use by the image processing algorithm(s) 609.

As described herein, in some examples, the systems and techniques can perform one or more operations to improve the use of information from a depth sensing system having a multi-point light source for image capture and processing operations. FIG. 6B is a diagram illustrating an example of a multi-point depth sensing controller 615 that can process multi-point depth information 612 and region of interest information 614 and output representative depth information for use by image processing algorithm(s) 619. The multi-point depth sensing controller 615 includes a region of interest (ROI) controller 616, a data analyzer 616, and a multi-subject optimizer 618.

In some aspects, the ROI controller 616 can extend an ROI (e.g., the ROI 704 of FIG. 7A) so that additional depth or distance information can be obtained from the depth sensing system having the multi-point light source. For instance, as shown in FIG. 7B, the ROI controller 616 can determine an extended ROI 714 for the image 710. Based on the extended ROI 714, depth information from additional elements of the grid (e.g., four depth values for the middle four elements of the grid 706, including one depth value per each grid element) can be determined and output to the data analyzer 617. With depth information from additional grids elements, a more stable depth result can be provided to the image processing algorithm(s) 619 (e.g., as compared to the example of FIG. 6A, where the limited available depth values associated with the ROI 704 may be insufficient as described above). Various techniques for determining an extended ROI are described below. In some examples, the ROI controller 616 only extends particular ROIs (referred to as “special” ROIs herein), such as ROIs determined using object detection (e.g., a face ROI determined using face detection, a vehicle ROI determined using vehicle detection), an input-based ROI (e.g., based on touch input, gesture input, voice input, and/or other input received from a user), and/or other ROI determined for a particular object or portion of an image. In such examples, the ROI controller 616 may not extend a general ROI that is set to a default position (e.g., a center position) within an image. For instance, a general ROI may be determined for an image when there is no object detected, when there is no user input received, etc.

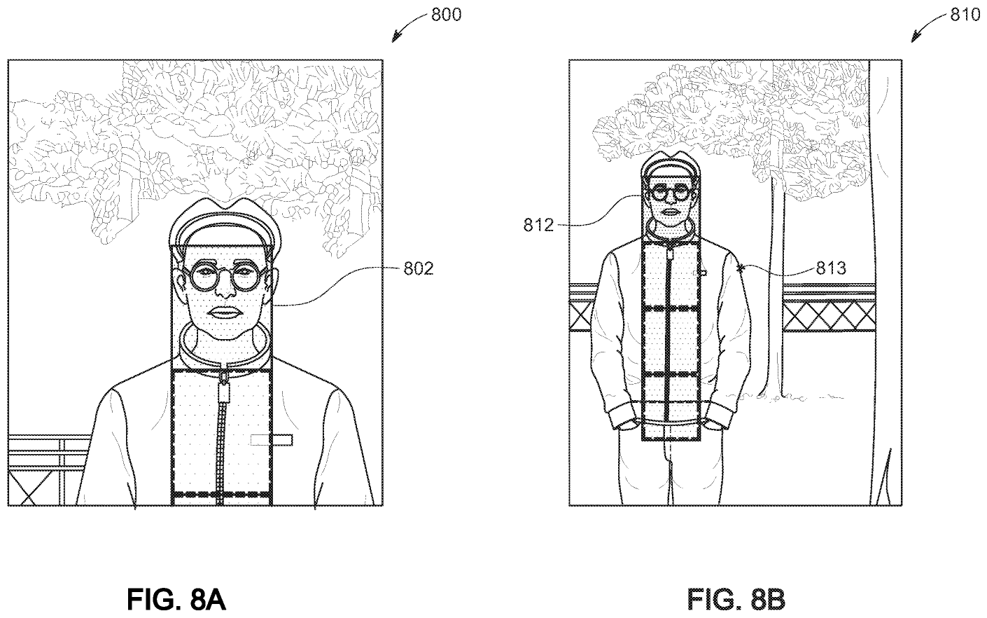

In some cases, the ROI controller 616 can determine an extended ROI based on a size and/or location of the ROI in an image. For instance, an ROI for a first object can be extended to encompass more grid elements than an ROI for a second object that is smaller than the first object. FIG. 8A is an image 810 illustrating an extended ROI 802 that includes a size that is two times the size of the original ROI (the original ROI is shown in FIG. 8A with solid lines, while the extended portion of the extended ROI 812 is sown with dashed lines). The original ROI is also referred to herein as a target ROI. FIG. 8B is an image 810 illustrating an extended ROI 812 that includes a size that is four times the size of the original ROI (the original ROI is shown in FIG. 8B with solid lines, while the extended portion of the extended ROI 812 is sown with dashed lines). The ROI 802 (in FIG. 8A) and the ROI 812 (in FIG. 8B) are extended in a downward direction due to the original ROI corresponding to a face of the person in the image 800 and the image 810, respectively. For example, by extending the original ROI in the downward direction, depth values of the person's body (which will have depth values that are within a threshold difference, such as a threshold difference of 10, of the depth values corresponding to the person's face) can be used to provide a more stable depth determination for use by the image capture or processing operations (e.g., auto-focus, auto-exposure, etc.). In some cases, the system can determine a person is lying down, sitting down, and/or positioned in a manner other than standing, in which case the ROI can be extended in a direction other than a downward direction. While the examples of FIG. 8A and FIG. 8B show the ROI being extended in a downward direction, the ROI controller 616 can extend an ROI in any direction (e.g., left, right, upward, and/or downward directions), such as depending on a type of object.

In some cases, the ROI controller 616 can use one or more size thresholds (or ranges) to determine an amount by which to extend an ROI. In one illustrative example, if the size of the ROI is less than a first size threshold, the ROI controller 616 can extend the ROI by a factor of one (to include one times the size of the original ROI) in one or more directions (e.g., to the left, right, upward, and/or downward directions, such as in a downward direction when the ROI corresponds to a face of a person as shown in FIG. 8A and FIG. 8B). In addition or alternatively, if the size of the ROI is less than a second size threshold and greater than the first size threshold, the ROI controller 616 can extend the ROI by a factor of two (to include two times the size of the original ROI) in the one or more directions. In addition or alternatively, if the size of the ROI is less than a third size threshold and greater than the first and second size thresholds, the ROI controller 616 can extend the ROI by a factor of three (to include three times the size) in the one or more directions. Fewer or more size thresholds can be used, such as depending on the number of grid elements in the grid. A size threshold can include a number of pixels (e.g., 100 pixels, 200 pixels, etc.), an absolute size (e.g., 2.5 centimeters, 5 centimeters, etc.), and/or other metric.

In addition or alternatively, the ROI controller 616 can determine an extended ROI based on a location of the ROI in an image relative to a reference point in the image. The reference point can include a center point of the image, a top-left point of the image, and/or other point or portion of the image. For instance, referring to FIG. 8B as an illustrative example, the original ROI (the portion of the extended ROI 812 depicted with solid lines) is located above and to the left of the center point 813 of the image 810. Based on the original ROI being located above and to the left of the center point 813 of the image 810, it can be assumed that more of the person's body is depicted in the image 810. The ROI controller 616 can thus (based on the original ROI being located above and to the left of the center point 813 of the image 810) generate the extended ROI 812 by extending the original ROI by a factor of four so that the ROI is four times its original size.

In some cases, the ROI controller 616 can extend an original ROI based on the size and location of the ROI. In one example, an ROI for a small (e.g., less than one or more size thresholds), off-center face will have a large extension. For instance, again referring to FIG. 8B as an illustrative example, based on the original ROI (depicted with solid lines) being small (e.g., less than one or more size thresholds) and being located above and to the left of the center point 813 of the image 810, it can be assumed that a large portion of the person's body is depicted in the image 810. The ROI controller 616 can thus (based on the original ROI being small and being located above and to the left of the center point 813 of the image 810) generate the extended ROI 812 by extending the original ROI by a factor of four.

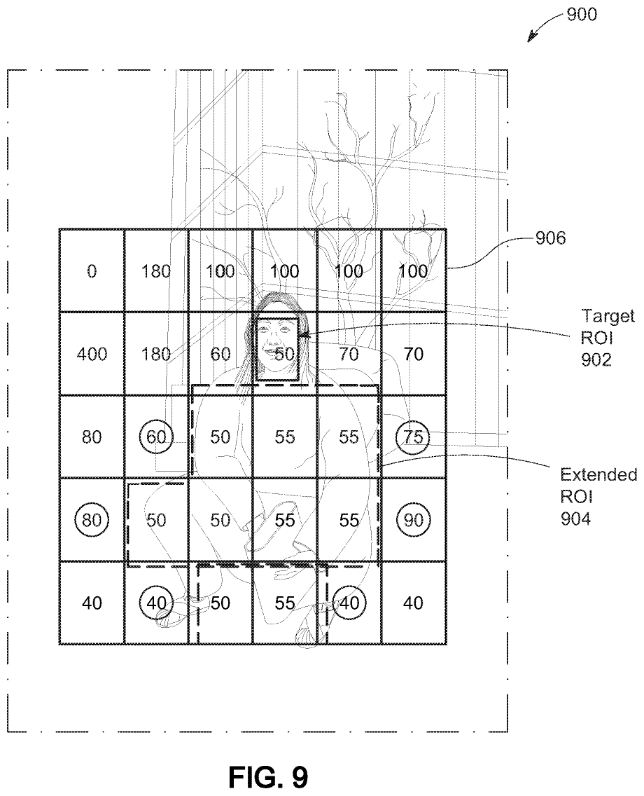

In some aspects, the ROI controller 616 can extend an ROI based on a coordinate correlation of a multi-point grid near a ROI of a target object. FIG. 9 is a diagram illustrating an example of extending a target ROI 902 (also referred to as an original ROI) based on a coordinate correlation of a multi-point grid 906 near the target ROI. For example, starting from the target ROI 902, the ROI controller 616 can search neighboring elements (or cells or zones) in the grid 906 (corresponding to different depth values in a depth map associated with the grid 906) to determine a difference between a depth assigned to the element of the multi-point grid corresponding to the target ROI 902 (a value of 50 in FIG. 9) and a depth of an element neighboring the element corresponding to the target ROI 902. The ROI controller 616 can then determine whether the difference is less than a threshold difference. If the difference of the depth value is within the threshold difference (and in some cases the confidence of the depth value is high, such as greater than a confidence threshold), the ROI controller 616 will determine the neighboring element is a valid extension because the depth values are similar. In such an example, the ROI controller 616 will extend the ROI to include the neighboring element. As noted above, in some cases the ROI controller 616 can determine whether to extend an ROI based on a confidence of a particular depth value to ensure that depth confidence of a particular grid element is trustworthy or otherwise valid. For instance, in addition to determining that a difference between an original or target ROI depth value and a depth value of a neighboring grid element is within the threshold difference, the ROI controller 616 can compare a confidence of the depth value (of the neighboring grid element) to a confidence threshold. In such an example, the ROI controller 616 will extend the ROI to include the neighboring element if the difference in depth values is within the threshold difference and the confidence of the neighboring element depth value is greater than the confidence threshold. In one illustrative example, the confidence threshold can be set to a value of 0.4, 0.5, 0.6, or other suitable value.

The direction and search range can be tunable parameters. For instance, the direction and search range can be tuned depending on the type of ROI (e.g., face ROI, object ROI, touch ROI, etc.), based on user preference, and/or based on other factors. For instance, a face ROI, a touch ROI, an object ROI (e.g., an ROI corresponding to a vehicle), and other kinds of ROIs may have different tunable parameters. In the example of FIG. 9, the search direction is in a downward direction (e.g., based on the ROI being a face ROI, in which case the body of the user is likely in a downward direction) and the threshold difference is set to a threshold of 10. In one example, the ROI controller 616 first searches a neighboring element immediately below the element including the target ROI 902. Because the neighboring element has a depth value of 55 and the element including the target ROI 902 has a depth value of 50, the depth values are within the threshold difference of 10. The ROI controller 616 can thus determine to extend the target ROI 902 to be associated with the neighboring element (increase the target ROI 902 by a factor of one in the downward direction). The ROI controller 616 can then search to the left of, to the right of, and below the neighboring element to determine if the depth values of those elements are within the threshold difference of the depth value of the element including the target ROI 902 (or within the threshold difference of the neighboring element in some cases). The depth values of the elements to the left of, to the right of, and below the neighboring element are within the threshold difference of the element including the target ROI 902, in which case the ROI controller 616 can extend the target ROI 902 to be associated with the neighboring element (increase the target ROI 902 by a factor of one in the right and left directions).

The ROI controller 616 can then search to the left of, to the right of, and below each of the elements having depth values that are within the threshold difference of depth value of the element including the target ROI 902 (or within the threshold difference of the corresponding element in some cases). In the example of FIG. 9, the ROI controller 616 eventually generates the extended ROI 904 so that the extended ROI 904 is associated with the depth values of the grid elements within the dotted line shown in FIG. 9. The depth values surrounded by circles are those depth values that are not within the threshold difference of the depth value of the element including the target ROI 902 (or within the threshold difference of the corresponding element in some cases).

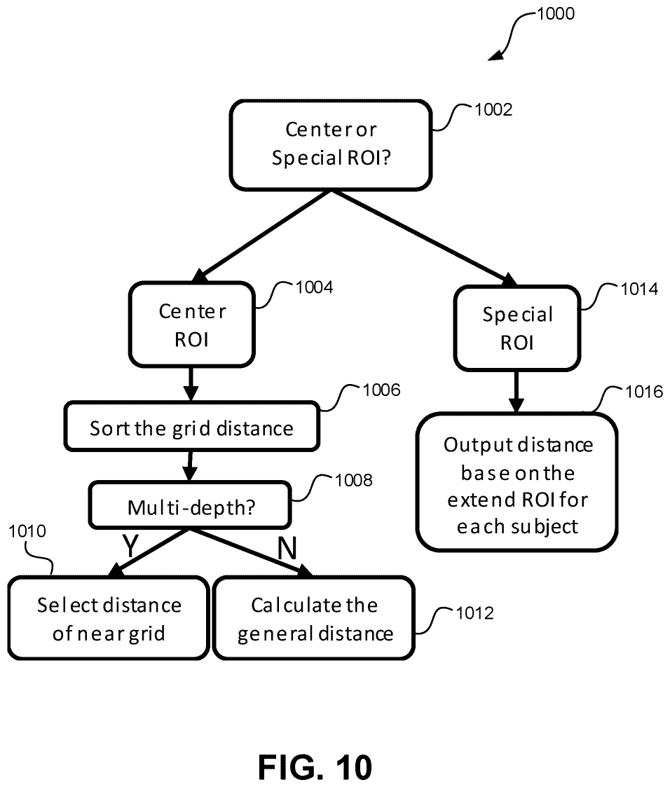

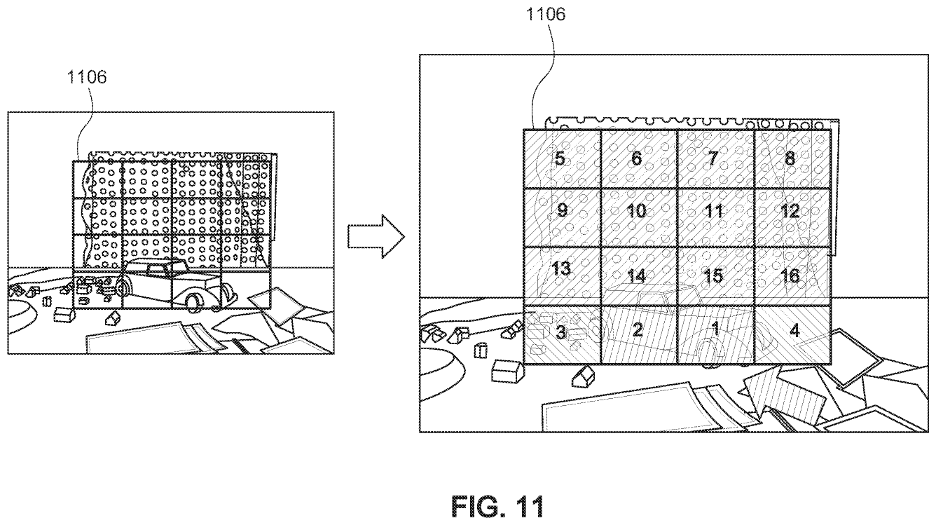

The data analyzer 617 can analyze the depth values associated with an extended ROI determined for an image (e.g., output by the ROI controller 616) or the depth values associated with a general ROI (e.g., a center ROI) determined for an image in order to determine a depth value or depth values to output to the multi-subject optimizer 618. FIG. 10 is a diagram illustrating an example of a process 1000 that can be performed by the data analyzer 617. The process 1000 will be described with respect to the images (overlaid with a multi-point grid 1106) shown in FIG. 11. Each cell of the multi-point grid 1106 can be associated with a corresponding depth value determined by a multi-point depth sensing system.

At block 1002 of the process 1000, the data analyzer 617 can determine whether an ROI determined for an image is a general ROI (e.g., a center ROI) or a special ROI. The special ROI can include an ROI determined using object detection (e.g., a face ROI determined using face detection, a vehicle ROI determined using vehicle detection), an input-based ROI (e.g., based on touch input, gesture input, voice input, and/or other input received from a user), and/or other ROI determined for a particular object or portion of an image. As noted above, in some cases, the general ROI may be determined for an image when there is no object detected, when there is no user input received, etc.

At block 1004, the data analyzer 617 determines that the ROI is a center ROI. Based on determining that the ROI is a center ROI, the data analyzer 617 may sort the distances (or depths) of the grid at block 1006. For instance, the data analyzer 617 can sort the distances (or depths) in order from nearest distances (e.g., smallest depths) to farthest distances (e.g., largest depths). Referring to FIG. 11 as an illustrative example, the grid elements (or cells or zones) of the grid 1106 are sorted from smallest depths to largest depths, with the order of the cells being shown numerically from 1 to 16. In some cases, block 1006 is optional, in which case the data analyzer 617 may not perform the operation of block 1006 in some implementations.

At block 1008, the data analyzer 617 can determine whether the scene depicted in the image (e.g., the ROI in the image) is a multi-depth scene based on depth values provided in associated with a multi-point grid (e.g., the grid 1106 shown in FIG. 11) from the multi-point depth sensing system. For example, the data analyzer 617 can determine whether a difference between a smallest depth value and a largest depth value from the elements in the multi-point grid is greater than or less than a multi-depth threshold. For instance, the multi-depth threshold can be set to 100 cm, 150 cm, 200 cm, or other suitable value. The data analyzer 617 can determine that the scene (e.g., the ROI) includes multi-depth information based on determining the difference between the smallest depth value and the largest depth value is greater than the multi-depth threshold. If the data analyzer 617 determines that the difference between the smallest depth value and the largest depth value is less than the multi-depth threshold, the data analyzer 617 can determine that the scene (e.g., the ROI) does not include multi-depth information.

If the data analyzer 617 determines that the scene is a multi-depth scene, the data analyzer 617 can select one of the nearest distances (or smallest depths) from the grid elements of the multi-point grid. For instance, the data analyzer 617 can selecting one of the nearest distances as the target distance using a tunable percentile selection process. In one illustrative example, the tunable percentile selection process can include selection of the first smallest depth (e.g., the depth value associated with the grid element having a value of 1 in FIG. 11), second smallest depth (e.g., the depth value associated with the grid element having a value of 2 in FIG. 11), third smallest depth (e.g., the depth value associated with the grid element having a value of 3 in FIG. 11), etc. by tuning. For instance, selecting the third smallest depth may provide the best processing (e.g., auto-focus, auto-exposure) balance for the multi-depth scene depicted in the image.

If the data analyzer 617 determines that the scene is not a multi-depth scene, the data analyzer 617 can select the general distance. In one example, the general distance can include the depth having the majority of values in the multi-point grid. For instance, the data analyzer 617 can determining a depth value associated with a majority of elements from the multi-point grid, and can select that depth value as the representative depth information for the center ROI.

At block 1014, the data analyzer 617 determines that the ROI is a special ROI. As noted above, the ROI controller 616 can generate an extended ROI for a special ROI. In some cases, as described herein, the ROI controller 616 can generate an extended ROI for multiple special ROIs determined for multiple objects in an image. Based on determining that the ROI is a special ROI, the data analyzer 617 at block 1016 can determine a respective distance for each ROI based on the extended ROI from the ROI controller 616 determined for each object detected or otherwise identified (e.g., based on user input) in the image. For instance, the data analyzer 617 can determine a representative depth value for an ROI based on depth values of the plurality of elements associated with the extended ROI (e.g., the four grid elements in the grid 706 that overlap with the ROI 714 of FIG. 7B). In one illustrative example, the representative depth value is an average of the depth values of the elements of the multi-point grid encompassed by the extended ROI (e.g., an average of the depth values associated with the four grid elements in the grid 706 that overlap with the ROI 714 of FIG. 7B).

The data analyzer 617 can output the one or more depth values (e.g., the depth value or distance determined at block 1010, block 1012, or block 1016 of FIG. 10) to the multi-subject optimizer 618. For instance, because the multi-point depth sensing controller 615 has access to the information from the entire multi-point grid, the controller 615 can utilize the information to handle a scene that includes multiple subjects (also referred to as objects). The multi-subject optimizer 618 can result in the image processing algorithm(s) (e.g., auto-focus, auto-exposure, etc.) generating images with better subjective visual quality when multiple subjects (or objects) are captured in an image.

If the output from the data analyzer 617 includes depth information (including a distance or depth value) for a single subject or object, the multi-subject optimizer 618 can output the distance or depth value for use by the image processing algorithm(s) 619.

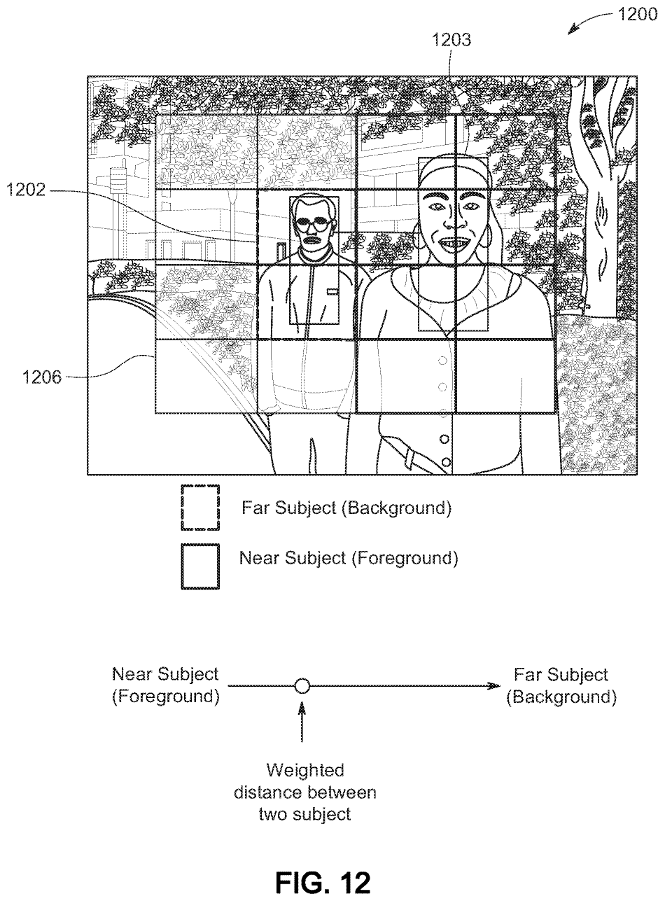

If the output from the data analyzer 617 includes depth information (including a distance or depth value) for a multiple subjects/object, the multi-subject optimizer 618 can analyze the distance or depth value output for each of the subjects by the data analyzer 617. FIG. 12 is an image 1200 that includes multiple subjects (including two people) at different depths relative to the camera used to capture the image 1200 (or relative to a multi-point light source based depth sensing system). As shown in FIG. 12, different elements of a multi-point grid 1204 (provided by the depth sensing system having the multi-point light source) overlaid over the image 1200 are associated with the two different subjects. The grid elements outlined in a thick solid outline include depth values associated with the subject closest or nearer to the camera or the depth sensing system (referred to as the near subject), and the grid elements outlined in a dashed outline include depth values associated with the subject further from the camera or the depth sensing system (referred to as the far subject). A first extended ROI 1202 is determined for the far subject and a second extended ROI 1203 is determined for the near subject.

Using auto-focus as an example image capture or processing operation, auto-focus generally focuses on the near subject which has a larger ROI. However, this would make the far subject (green one) blurry. Using the information from a depth sensing system with multi-point light source (e.g., depth or distance values included in the multi-point grid 1206), the multi-subject optimizer 618 can take into account both subjects for determining a position in the image for focus or other image capture or processing operation (e.g., auto-exposure, auto-white-balance, etc.). In one example, the multi-subject optimizer 618 can determine combined distance or depth information based on the distance or depth information output by the data analyzer 617 for the far subject and the distance or depth information output by the data analyzer 617 for the near subject. In one illustrative example, as shown in FIG. 12, the multi-subject optimizer 618 can determine the combined distance or depth information by determining a weighted average of the depth or distance value output by the data analyzer 617 for the far subject and the depth or distance value output by the data analyzer 617 for the near subject. Using such a combined distance or depth value can allow the image processing algorithm(s) 619 to generate an output image having a balanced result with both subjects appearing with visually pleasing characteristics.

The multi-subject optimizer 618 can output representative depth information representing a distance between the camera used to capture the image (or the depth sensing system) and the one or more subjects or objects depicted in the image. The image processing algorithm(s) 619 can use the representative depth information output from the multi-subject optimizer 618 to perform one or more image capture or processing operations (e.g., auto-focus, auto-exposure, auto-white-balance, auto-zoom, and/or other operations) on the portion of the image 710 that is within the ROI 704 or the extended ROI 714.

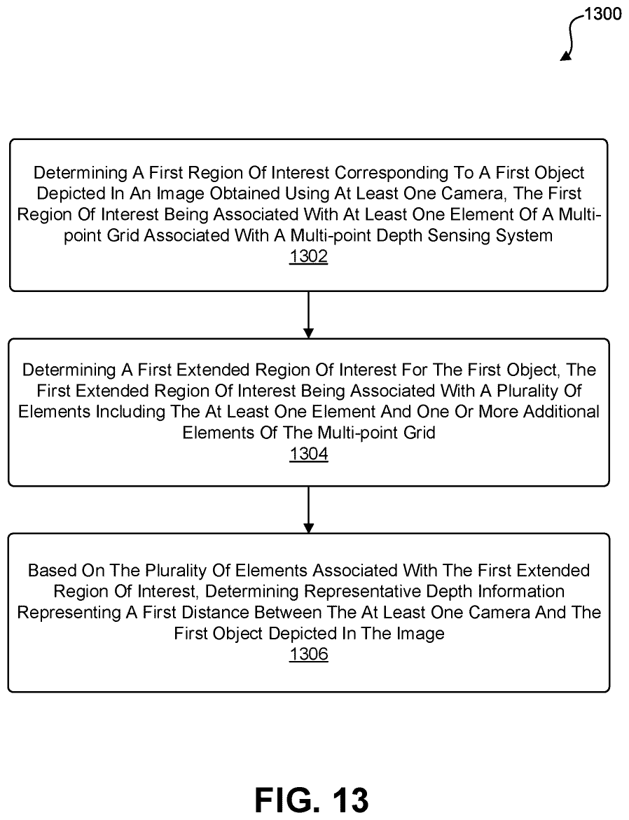

FIG. 13 is a flow diagram illustrating an example of a process 1300 for processing image data using one or more of the techniques described herein. At block 1302, the process 1300 includes determining a first region of interest corresponding to a first object depicted in an image obtained using at least one camera. The first region of interest is associated with at least one element (or cell or zone) of a multi-point grid associated with a multi-point depth sensing system. For instance, referring to FIG. 7B as an illustrative example, the original or target region of interest (ROI) (the top-most portion of the extended ROI 714) is associated with two elements of the grid 706 (the element in the second row and second column of the grid 706 and the element in the second row and third column of the grid 706).

At block 1304, the process 1300 includes determining a first extended region of interest for the first object. The first extended region of interest is associated with a plurality of elements including the at least one element and one or more additional elements of the multi-point grid. For instance, again referring to FIG. 7B as an illustrative example, the extended ROI 714 is associated with four elements of the grid 706 (the element in the second row and second column of the grid 706, the element in the second row and third column of the grid 706, the element in the third row and second column of the grid 706, and the element in the third row and third column of the grid 706).

In some examples, to determine the first extended region of interest for the first object, the process 1300 can include determining at least one of a size of the first region of interest and a location of the first region of interest relative to a reference point in the image. The process 1300 can include determining the first extended region of interest for the first object based on at least one of the size and the location of the first region of interest. Illustrative examples of determining an extended ROI based on size and/or location are described above with respect to FIG. 8A and FIG. 8B. In some cases, to determine the first extended region of interest for the first object, the process 1300 can include determining the first extended region of interest for the first object based on the size of the first region of interest. In some cases, to determine the first extended region of interest for the first object, the process 1300 can include determining the first extended region of interest for the first object based on the location of the first region of interest. In some cases, to determine the first extended region of interest for the first object, the process 1300 can include determining the first extended region of interest for the first object based on the size and the location of the first region of interest.

In some aspects, the process 1300 can determine the first extended region of interest based on a coordinate correlation of a multi-point grid near the target ROI. An illustrative example of determining an extended ROI based on a coordinate correlation of a multi-point grid near the target ROI is described above with respect to FIG. 9. For instance, to determine the first extended region of interest for the first object, the process 1300 can include determining a first depth associated with a first element of the one or more additional elements of the multi-point grid. The first element neighbors the at least one element associated with the first region of interest. The process 1300 can include determining a difference between the first depth and a depth of the at least one element associated with the first region of interest is less than a threshold difference. The process 1300 can further include associating the first element with the first extended region of interest based on determining the difference between the first depth and the depth of the at least one element associated with the first region of interest is less than the threshold difference. In some aspects, the process 1300 can associate the first element with the first extended region of interest further based on a confidence of the first depth being greater than a confidence threshold.

In some examples, the process 1300 can include determining a second depth associated with a second element of the one or more additional elements of the multi-point grid. The second element is neighboring the first element of the one or more additional elements. The process 1300 can include determining a difference between the second depth and the first depth is less than the threshold difference. The process 1300 can further include associating the second element with the first extended region of interest based on determining the difference between the second depth and the first depth is less than the threshold difference.

In some aspects, the process 1300 can include determining a second depth associated with a second element of the one or more additional elements of the multi-point grid. The second element is neighboring the first element of the one or more additional elements. The process 1300 can include determining the difference between the second depth and the first depth is greater than the threshold difference. The process 1300 can further include excluding the second element from the first extended region of interest based on determining the difference between the second depth and the first depth is greater than the threshold difference.

At block 1306, the process 1300 includes determining, based on the plurality of elements associated with the first extended region of interest, representative depth information representing a first distance between the at least one camera and the first object depicted in the image. In some cases, the process 1300 can include processing the image based on the representative depth information representing the first distance. For instance, processing the image can include performing automatic-exposure, automatic-focus, automatic-white-balance, automatic-zoom, and/or other operation(s) on at least the first region of interest of the image. In some aspects, the multi-point depth sensing system includes a transmitter including a plurality of light sources and a receiver configured to receive reflections of light emitted by the plurality of light sources. In some cases, the representative depth information is determined based on the received reflections of light.

In some cases, to determine the representative depth information representing the first distance, the process 1300 can include determining a representative depth value for the first extended region of interest based on depth values of the plurality of elements associated with the first extended region of interest. In some aspects, the representative depth value includes an average of the depth values of the plurality of elements associated with the first extended region of interest.

In some aspects, the process 1300 can include processing, based on the first region of interest being the only region of interest determined for the image, the image based on the representative depth information representing the first distance. For instance, the process 1300 can include determining that the first region of interest is the only region of interest and, based on the first region of interest being the only region of interest determined for the image, the process 1300 can process the image based on the representative depth information representing the first distance.

In some aspects, the process 1300 can include determining a second region of interest corresponding to a second object depicted in the image. The second region of interest is associated with at least one additional element of the multi-point grid associated with the multi-point depth sensing system. The process 1300 can include determining a second extended region of interest for the second object. The second extended region of interest is associated with a plurality of elements including the at least one additional element and second one or more additional elements of the multi-point grid. The process 1300 can include determining, based on the plurality of elements associated with the second extended region of interest, representative depth information representing a second distance between the at least one camera and the second object depicted in the image. In some cases, the process 1300 can include determining combined depth information based on the representative depth information representing the first distance and the representative depth information representing the second distance. In some cases, to determine the combined depth information, the process 1300 can include determining a weighted average of the representative depth information representing the first distance and the representative depth information representing the second distance.

In some aspects, the process 1300 can include processing the image based on the combined depth information. In some cases, to process the image based on the combined depth information, the process 1300 can include performing automatic-exposure, automatic-focus, automatic-white-balance, automatic-zoom, and/or other operation(s) on at least the first region of interest of the image.

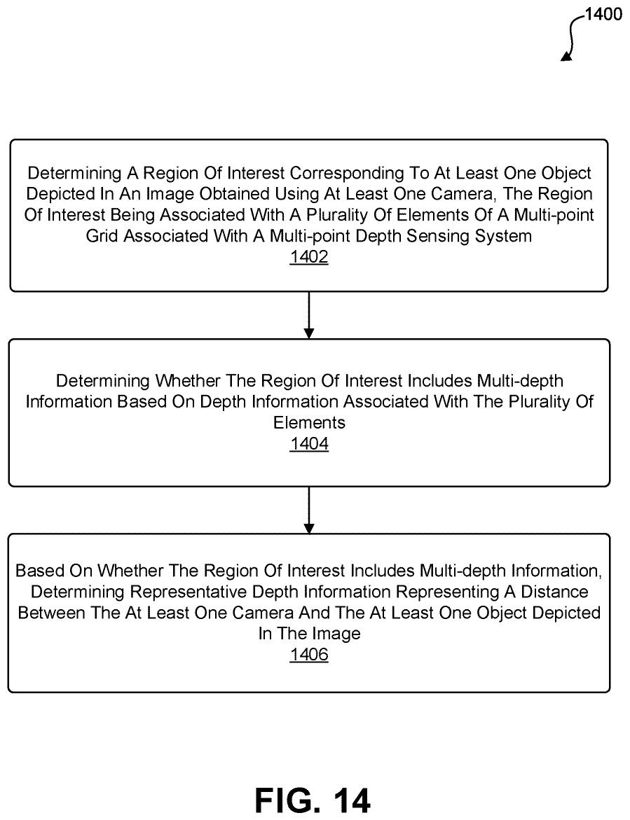

FIG. 14 is a flow diagram illustrating another example of a process 1400 for processing image data using one or more of the techniques described herein. At block 1402, the process 1400 includes determining a region of interest corresponding to at least one object depicted in an image obtained using at least one camera. The region of interest is associated with a plurality of elements of a multi-point grid associated with a multi-point depth sensing system.

At block 1404, the process 1400 includes determining whether the region of interest includes multi-depth information based on depth information associated with the plurality of elements.

At block 1406, the process 1400 includes determining, based on whether the region of interest includes multi-depth information, representative depth information representing a distance between the at least one camera and the at least one object depicted in the image. In some aspects, the process 1400 can include processing the image based on the representative depth information representing the distance. In some cases, to process the image, the process 1400 can include performing automatic-exposure, automatic-focus, automatic-white-balance, automatic-zoom, and/or other operation(s) on at least the region of interest of the image. In some examples, the multi-point depth sensing system includes a transmitter including a plurality of light sources and a receiver configured to receive reflections of light emitted by the plurality of light sources. In some cases, the representative depth information is determined based on the received reflections of light.

In some cases, the process 1400 can include sorting the plurality of elements according to the representative depth information associated with the plurality of elements. For instance, the process 1400 can sort the plurality of elements from smallest depth to largest depth (e.g., as shown in and described with respect to FIG. 11).

In some examples, to determine whether the region of interest includes the multi-depth information, the process 1400 can include determining a difference between a smallest depth value of the plurality of elements and a largest depth value of the plurality of elements is greater than a multi-depth threshold (e.g., 100 cm, 150 cm, 200 cm, or other suitable value). The process 1400 can include determining the region of interest includes multi-depth information based on determining the difference between the smallest depth value and the largest depth value is greater than the multi-depth threshold. In such examples, to determine the representative depth information, the process 1400 can include selecting a second or third smallest depth value as the representative depth information (e.g., according to the tunable percentile selection process described above with respect to FIG. 6 and FIG. 11).

In some examples, to determine whether the region of interest includes the multi-depth information, the process 1400 can include determining a difference between a smallest depth value of the plurality of elements and a largest depth value of the plurality of elements is less than the multi-depth threshold. The process 1400 can include determining the region of interest does not include multi-depth information based on determining the difference between the smallest depth value and the largest depth value is less than the multi-depth threshold. In such examples, to determine the representative depth information, the process 1400 can include determining a depth value associated with a majority of elements from the plurality of elements of the multi-point grid. The process 1400 can include selecting the depth value as the representative depth information.

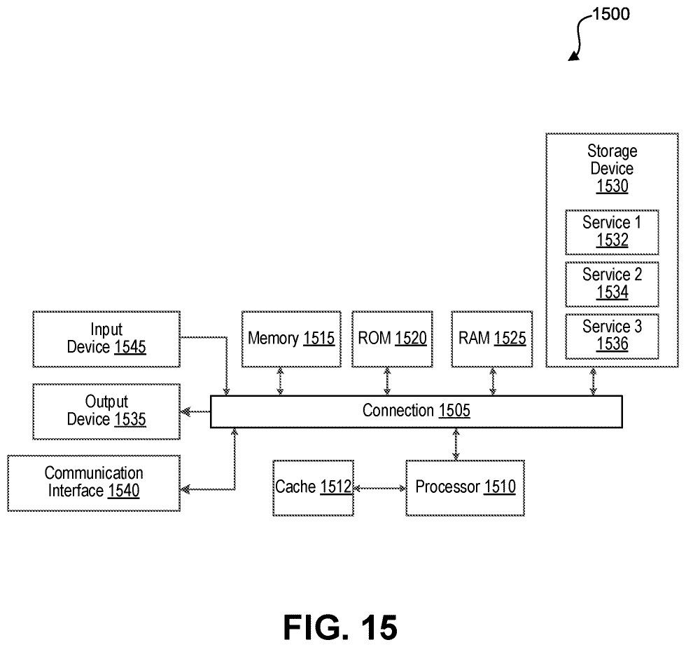

In some examples, the processes described herein (e.g., process 1000, process 1300, the process 1400, and/or other process described herein) may be performed by a computing device or apparatus (e.g., the multi-point depth sensing controller of FIG. 6B, the image capture and processing system 100 of FIG. 1, a computing device with the computing system 1500 of FIG. 15, or other device). For instance, a computing device with the computing architecture shown in FIG. 15 can include the components of the multi-point depth sensing controller of FIG. 6B and can implement the operations of FIG. 10, FIG. 13, and/or FIG. 14.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the process 1000, the process 1300, and/or the process 1400. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1000, the process 1300, and the process 1400 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1000, the process 1300, the process 1400, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 15 is a diagram illustrating an example of a system for implementing certain aspects of the present technology. In particular, FIG. 15 illustrates an example of computing system 1500, which can be for example any computing device making up internal computing system, a remote computing system, a camera, or any component thereof in which the components of the system are in communication with each other using connection 1505. Connection 1505 can be a physical connection using a bus, or a direct connection into processor 1510, such as in a chipset architecture. Connection 1505 can also be a virtual connection, networked connection, or logical connection.

In some embodiments, computing system 1500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1500 includes at least one processing unit (CPU or processor) 1510 and connection 1505 that couples various system components including system memory 1515, such as read-only memory (ROM) 1520 and random access memory (RAM) 1525 to processor 1510. Computing system 1500 can include a cache 1512 of high-speed memory connected directly with, in close proximity to, or integrated as part of processor 1510.

Processor 1510 can include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction, computing system 1500 includes an input device 1545, which can represent any number of input mechanisms, such as a microphone for speech, a touch-sensitive screen for gesture or graphical input, keyboard, mouse, motion input, speech, etc. Computing system 1500 can also include output device 1535, which can be one or more of a number of output mechanisms. In some instances, multimodal systems can enable a user to provide multiple types of input/output to communicate with computing system 1500. Computing system 1500 can include communications interface 1540, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple R Lightning R port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1530 can include software services, servers, services, etc., that when the code that defines such software is executed by the processor 1510, it causes the system to perform a function. In some embodiments, a hardware service that performs a particular function can include the software component stored in a computer-readable medium in connection with the necessary hardware components, such as processor 1510, connection 1505, output device 1535, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include, but are not limited to, the following aspects:

Aspect 1: A method of processing image data, the method comprising: determining a first region of interest corresponding to a first object depicted in an image obtained using at least one camera, the first region of interest being associated with at least one element of a multi-point grid associated with a multi-point depth sensing system: determining a first extended region of interest for the first object, the first extended region of interest being associated with a plurality of elements including the at least one element and one or more additional elements of the multi-point grid: and based on the plurality of elements associated with the first extended region of interest, determining representative depth information representing a first distance between the at least one camera and the first object depicted in the image.

Aspect 2: The method of aspect 1, further comprising: processing the image based on the representative depth information representing the first distance, wherein processing the image includes performing at least one of automatic-exposure, automatic-focus, automatic-white-balance, and automatic-zoom on at least the first region of interest of the image.

Aspect 3: The method of any one of aspects 1 or 2, wherein determining the first extended region of interest for the first object includes: determining at least one of a size of the first region of interest and a location of the first region of interest relative to a reference point in the image: and determining the first extended region of interest for the first object based on at least one of the size and the location of the first region of interest.

Aspect 4: The method of aspect 3, wherein determining the first extended region of interest for the first object includes: determining the first extended region of interest for the first object based on the size of the first region of interest.

Aspect 5: The method of aspect 3, wherein determining the first extended region of interest for the first object includes: determining the first extended region of interest for the first object based on the location of the first region of interest.

Aspect 6: The method of aspect 3, wherein determining the first extended region of interest for the first object includes: determining the first extended region of interest for the first object based on the size and the location of the first region of interest.

Aspect 7: The method of any one of aspects 1 or 2, wherein determining the first extended region of interest for the first object includes: determining a first depth associated with a first element of the one or more additional elements of the multi-point grid, the first element neighboring the at least one element associated with the first region of interest; determining a difference between the first depth and a depth of the at least one element associated with the first region of interest is less than a threshold difference: and associating the first element with the first extended region of interest based on determining the difference between the first depth and the depth of the at least one element associated with the first region of interest is less than the threshold difference.

Aspect 8: The method of aspect 7, wherein associating the first element with the first extended region of interest is further based on a confidence of the first depth being greater than a confidence threshold.

Aspect 9: The method of any one of aspects 7 or 8, further comprising: determining a second depth associated with a second element of the one or more additional elements of the multi-point grid, the second element neighboring the first element of the one or more additional elements: determining a difference between the second depth and the first depth is less than the threshold difference: and associating the second element with the first extended region of interest based on determining the difference between the second depth and the first depth is less than the threshold difference.

Aspect 10: The method of any one of aspects 7 or 8, further comprising: determining a second depth associated with a second element of the one or more additional elements of the multi-point grid, the second element neighboring the first element of the one or more additional elements; determining the difference between the second depth and the first depth is greater than the threshold difference; and excluding the second element from the first extended region of interest based on determining the difference between the second depth and the first depth is greater than the threshold difference.

Aspect 11: The method of any one of aspects 1 to 10, wherein determining the representative depth information representing the first distance includes: determining a representative depth value for the first extended region of interest based on depth values of the plurality of elements associated with the first extended region of interest.

Aspect 12: The method of aspect 11, wherein the representative depth value includes an average of the depth values of the plurality of elements associated with the first extended region of interest.

Aspect 13: The method of any one of aspects 1 to 12, further comprising: based on the first region of interest being the only region of interest determined for the image, processing the image based on the representative depth information representing the first distance.

Aspect 14: The method of aspect 13, wherein processing the image based on the representative depth information representing the first distance includes performing at least one of automatic-exposure, automatic-focus, automatic-white-balance, and automatic-zoom on at least the first region of interest of the image.

Aspect 15: The method of any one of aspects 1 to 14, further comprising: determining a second region of interest corresponding to a second object depicted in the image, the second region of interest being associated with at least one additional element of the multi-point grid associated with the multi-point depth sensing system: determining a second extended region of interest for the second object, the second extended region of interest being associated with a plurality of elements including the at least one additional element and second one or more additional elements of the multi-point grid: and based on the plurality of elements associated with the second extended region of interest, determining representative depth information representing a second distance between the at least one camera and the second object depicted in the image.

Aspect 16: The method of aspect 15, further comprising: determining combined depth information based on the representative depth information representing the first distance and the representative depth information representing the second distance.

Aspect 17: The method of aspect 16, wherein determining the combined depth information includes determining a weighted average of the representative depth information representing the first distance and the representative depth information representing the second distance.

Aspect 18: The method of any one of aspects 16 or 17, further comprising: processing the image based on the combined depth information.

Aspect 19: The method of aspect 18, wherein processing the image based on the combined depth information includes performing at least one of automatic-exposure, automatic-focus, automatic-white-balance, and automatic-zoom on at least the first region of interest of the image.

Aspect 20: The method of any one of aspects 1 to 19, wherein the multi-point depth sensing system includes a transmitter including a plurality of light sources and a receiver configured to receive reflections of light emitted by the plurality of light sources, and wherein the representative depth information is determined based on the received reflections of light.

Aspect 21: An apparatus for processing image data, comprising at least one memory and at least one processor coupled to the at least one memory. The at least one processor is configured to: determine a first region of interest corresponding to a first object depicted in an image obtained using at least one camera, the first region of interest being associated with at least one element of a multi-point grid associated with a multi-point depth sensing system; determine a first extended region of interest for the first object, the first extended region of interest being associated with a plurality of elements including the at least one element and one or more additional elements of the multi-point grid: and based on the plurality of elements associated with the first extended region of interest, determine representative depth information representing a first distance between the at least one camera and the first object depicted in the image.

Aspect 22: The apparatus of aspect 21, wherein the at least one processor is configured to: process the image based on the representative depth information representing the first distance, wherein processing the image includes performing at least one of automatic-exposure, automatic-focus, automatic-white-balance, and automatic-zoom on at least the first region of interest of the image.

Aspect 23: The apparatus of any one of aspects 21 or 22, wherein, to determine the first extended region of interest for the first object, the at least one processor is configured to: determine at least one of a size of the first region of interest and a location of the first region of interest relative to a reference point in the image: and determine the first extended region of interest for the first object based on at least one of the size and the location of the first region of interest.

Aspect 24: The apparatus of aspect 23, wherein, to determine the first extended region of interest for the first object, the at least one processor is configured to: determine the first extended region of interest for the first object based on the size of the first region of interest.

Aspect 25: The apparatus of aspect 23, wherein, to determine the first extended region of interest for the first object, the at least one processor is configured to: determine the first extended region of interest for the first object based on the location of the first region of interest.

Aspect 26: The apparatus of aspect 23, wherein, to determine the first extended region of interest for the first object, the at least one processor is configured to: determine the first extended region of interest for the first object based on the size and the location of the first region of interest.

Aspect 27: The apparatus of any one of aspects 21 or 22, wherein, to determine the first extended region of interest for the first object, the at least one processor is configured to: determine a first depth associated with a first element of the one or more additional elements of the multi-point grid, the first element neighboring the at least one element associated with the first region of interest: determine a difference between the first depth and a depth of the at least one element associated with the first region of interest is less than a threshold difference; and associate the first element with the first extended region of interest based on determining the difference between the first depth and the depth of the at least one element associated with the first region of interest is less than the threshold difference.

Aspect 28: The apparatus of aspect 27, wherein the at least one processor is configured to associate the first element with the first extended region of interest further based on a confidence of the first depth being greater than a confidence threshold.

Aspect 29: The apparatus of any one of aspects 27 or 28, wherein the at least one processor is configured to: determine a second depth associated with a second element of the one or more additional elements of the multi-point grid, the second element neighboring the first element of the one or more additional elements; determine a difference between the second depth and the first depth is less than the threshold difference: and associate the second element with the first extended region of interest based on determining the difference between the second depth and the first depth is less than the threshold difference.

Aspect 30: The apparatus of any one of aspects 27 or 28, wherein the at least one processor is configured to: determine a second depth associated with a second element of the one or more additional elements of the multi-point grid, the second element neighboring the first element of the one or more additional elements; determine the difference between the second depth and the first depth is greater than the threshold difference: and exclude the second element from the first extended region of interest based on determining the difference between the second depth and the first depth is greater than the threshold difference.

Aspect 31: The apparatus of any one of aspects 21 to 30, wherein, to determine the representative depth information representing the first distance, the at least one processor is configured to: determining a representative depth value for the first extended region of interest based on depth values of the plurality of elements associated with the first extended region of interest.

Aspect 32: The apparatus of aspect 31, wherein the representative depth value includes an average of the depth values of the plurality of elements associated with the first extended region of interest.

Aspect 33: The apparatus of any one of aspects 21 to 32, wherein the at least one processor is configured to: based on the first region of interest being the only region of interest determined for the image, process the image based on the representative depth information representing the first distance.

Aspect 34: The apparatus of aspect 33, wherein, to process the image based on the representative depth information representing the first distance, the at least one processor is configured to perform at least one of automatic-exposure, automatic-focus, automatic-white-balance, and automatic-zoom on at least the first region of interest of the image.

Aspect 35: The apparatus of any one of aspects 21 to 34, wherein the at least one processor is configured to: determine a second region of interest corresponding to a second object depicted in the image, the second region of interest being associated with at least one additional element of the multi-point grid associated with the multi-point depth sensing system; determine a second extended region of interest for the second object, the second extended region of interest being associated with a plurality of elements including the at least one additional element and second one or more additional elements of the multi-point grid; and based on the plurality of elements associated with the second extended region of interest, determine representative depth information representing a second distance between the at least one camera and the second object depicted in the image.

Aspect 36: The apparatus of aspect 35, wherein the at least one processor is configured to: determine combined depth information based on the representative depth information representing the first distance and the representative depth information representing the second distance.

Aspect 37: The apparatus of aspect 36, wherein, to determine the combined depth information, the at least one processor is configured to determine a weighted average of the representative depth information representing the first distance and the representative depth information representing the second distance.

Aspect 38: The apparatus of any one of aspects 36 or 37, wherein the at least one processor is configured to: process the image based on the combined depth information.

Aspect 39: The apparatus of aspect 38, wherein, to process the image based on the combined depth information, the at least one processor is configured to perform at least one of automatic-exposure, automatic-focus, automatic-white-balance, and automatic-zoom on at least the first region of interest of the image.

Aspect 40: The apparatus of any one of aspects 21 to 39, wherein the multi-point depth sensing system includes a transmitter including a plurality of light sources and a receiver configured to receive reflections of light emitted by the plurality of light sources, and wherein the representative depth information is determined based on the received reflections of light.

Aspect 41: A non-transitory computer-readable storage medium comprising instructions stored thereon which, when executed by one or more processors, cause the one or more processors to perform operations of any of aspects 1 to 40.

Aspect 42: An apparatus for processing image data, the apparatus comprising means for performing operations of any of aspects 1 to 40.

Aspect 43: A method of processing image data, the method comprising: determining a region of interest corresponding to at least one object depicted in an image obtained using at least one camera, the region of interest being associated with a plurality of elements of a multi-point grid associated with a multi-point depth sensing system: determining whether the region of interest includes multi-depth information based on depth information associated with the plurality of elements; and based on whether the region of interest includes multi-depth information, determining representative depth information representing a distance between the at least one camera and the at least one object depicted in the image.

Aspect 44: The method of aspect 43, further comprising: sorting the plurality of elements according to the representative depth information associated with the plurality of elements, wherein the plurality of elements are sorted from smallest depth to largest depth.

Aspect 45: The method of any one of aspects 43 or 44, wherein determining whether the region of interest includes the multi-depth information includes: determining a difference between a smallest depth value of the plurality of elements and a largest depth value of the plurality of elements is greater than a multi-depth threshold: and determining the region of interest includes multi-depth information based on determining the difference between the smallest depth value and the largest depth value is greater than the multi-depth threshold.

Aspect 46: The method of aspect 45, wherein determining the representative depth information includes: selecting a second or third smallest depth value as the representative depth information.

Aspect 47: The method of any one of aspects 43 or 44, wherein determining whether the region of interest includes the multi-depth information includes: determining a difference between a smallest depth value of the plurality of elements and a largest depth value of the plurality of elements is less than a multi-depth threshold: and determining the region of interest does not include multi-depth information based on determining the difference between the smallest depth value and the largest depth value is less than the multi-depth threshold.

Aspect 48: The method of aspect 47, wherein determining the representative depth information includes: determining a depth value associated with a majority of elements from the plurality of elements of the multi-point grid: and selecting the depth value as the representative depth information.

Aspect 49: The method of any one of aspects 43 to 48, further comprising: processing the image based on the representative depth information representing the distance, wherein processing the image includes performing at least one of automatic-exposure, automatic-focus, automatic-white-balance, and automatic-zoom on at least the region of interest of the image.

Aspect 50: The method of any one of aspects 43 to 49, wherein the multi-point depth sensing system includes a transmitter including a plurality of light sources and a receiver configured to receive reflections of light emitted by the plurality of light sources, and wherein the representative depth information is determined based on the received reflections of light.

Aspect 51: An apparatus for processing image data, comprising at least one memory and at least one processor coupled to the at least one memory. The at least one processor is configured to: determine a region of interest corresponding to at least one object depicted in an image obtained using at least one camera, the region of interest being associated with a plurality of elements of a multi-point grid associated with a multi-point depth sensing system: determine whether the region of interest includes multi-depth information based on depth information associated with the plurality of elements: and based on whether the region of interest includes multi-depth information, determine representative depth information representing a distance between the at least one camera and the at least one object depicted in the image.

Aspect 52: The apparatus of aspect 51, wherein the at least one processor is configured to: sort the plurality of elements according to the representative depth information associated with the plurality of elements, wherein the plurality of elements are sorted from smallest depth to largest depth.

Aspect 53: The apparatus of any one of aspects 51 or 52, wherein, to determine whether the region of interest includes the multi-depth information, the at least one processor is configured to: determine a difference between a smallest depth value of the plurality of elements and a largest depth value of the plurality of elements is greater than a multi-depth threshold: and determine the region of interest includes multi-depth information based on determining the difference between the smallest depth value and the largest depth value is greater than the multi-depth threshold.

Aspect 54: The apparatus of aspect 53, wherein, to determine the representative depth information, the at least one processor is configured to: select a second or third smallest depth value as the representative depth information.

Aspect 55: The apparatus of any one of aspects 51 or 52, wherein, to determine whether the region of interest includes the multi-depth information, the at least one processor is configured to: determine a difference between a smallest depth value of the plurality of elements and a largest depth value of the plurality of elements is less than a multi-depth threshold; and determine the region of interest does not include multi-depth information based on determining the difference between the smallest depth value and the largest depth value is less than the multi-depth threshold.

Aspect 56: The apparatus of aspect 55, wherein, to determine the representative depth information, the at least one processor is configured to: determine a depth value associated with a majority of elements from the plurality of elements of the multi-point grid: and select the depth value as the representative depth information.

Aspect 57: The apparatus of any one of aspects 51 to 56, wherein the at least one processor is configured to: process the image based on the representative depth information representing the distance, wherein processing the image includes performing at least one of automatic-exposure, automatic-focus, automatic-white-balance, and automatic-zoom on at least the region of interest of the image.

Aspect 58: The apparatus of any one of aspects 51 to 57, wherein the multi-point depth sensing system includes a transmitter including a plurality of light sources and a receiver configured to receive reflections of light emitted by the plurality of light sources, and wherein the representative depth information is determined based on the received reflections of light.

Aspect 59: A non-transitory computer-readable storage medium comprising instructions stored thereon which, when executed by one or more processors, cause the one or more processors to perform operations of any of aspects 43 to 59.

Aspect 60: An apparatus for processing image data, the apparatus comprising means for performing operations of any of aspects 43 to 59.

Aspect 61: A method of for processing image data, the method including operations according to any of aspects 1 to 40 and any of aspects 43 to 59.

Aspect 62: An apparatus for processing image data, the apparatus comprising at least one memory and at least one processor coupled to the at least one memory. The at least one processor is configured to perform operations of any of aspects 1 to 40 and any of aspects 43 to 59.

Aspect 63: A non-transitory computer-readable storage medium comprising instructions stored thereon which, when executed by one or more processors, cause the one or more processors to perform operations of any of aspects 1 to 40 and any of aspects 43 to 59.

Aspect 64: An apparatus for processing image data, the apparatus comprising means for performing operations of any of aspects 1 to 40 and any of aspects 43 to 59.

1. A method of processing image data, the method comprising:
determining a first region of interest corresponding to a first object depicted in an image obtained using at least one camera, the first region of interest being associated with at least one element of a multi-point grid associated with a multi-point depth sensing system;
determining a first extended region of interest for the first object, the first extended region of interest being associated with a plurality of elements including the at least one element and one or more additional elements of the multi-point grid; and
based on the plurality of elements associated with the first extended region of interest, determining representative depth information representing a first distance between the at least one camera and the first object depicted in the image.

2. The method of claim 1, further comprising:
processing the image based on the representative depth information representing the first distance, wherein processing the image includes performing at least one of automatic-exposure, automatic-focus, automatic-white-balance, and automatic-zoom on at least the first region of interest of the image.

3. The method of claim 1, wherein determining the first extended region of interest for the first object includes:
determining at least one of a size of the first region of interest and a location of the first region of interest relative to a reference point in the image; and
determining the first extended region of interest for the first object based on at least one of the size and the location of the first region of interest.

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. An apparatus for processing image data, comprising:
at least one memory; and
at least one processor coupled to the at least one memory, the at least one processor configured to:
determine a first region of interest corresponding to a first object depicted in an image obtained using at least one camera, the first region of interest being associated with at least one element of a multi-point grid associated with a multi-point depth sensing system;
determine a first extended region of interest for the first object, the first extended region of interest being associated with a plurality of elements including the at least one element and one or more additional elements of the multi-point grid; and
based on the plurality of elements associated with the first extended region of interest, determine representative depth information representing a first distance between the at least one camera and the first object depicted in the image.

22. The apparatus of claim 21, wherein the at least one processor is configured to:
process the image based on the representative depth information representing the first distance, wherein processing the image includes performing at least one of automatic-exposure, automatic-focus, automatic-white-balance, and automatic-zoom on at least the first region of interest of the image.

23. The apparatus of claim 21, wherein, to determine the first extended region of interest for the first object, the at least one processor is configured to:
determine at least one of a size of the first region of interest and a location of the first region of interest relative to a reference point in the image; and
determine the first extended region of interest for the first object based on at least one of the size and the location of the first region of interest.

24. The apparatus of claim 23, wherein, to determine the first extended region of interest for the first object, the at least one processor is configured to:
determine the first extended region of interest for the first object based on the size of the first region of interest.

25. The apparatus of claim 23, wherein, to determine the first extended region of interest for the first object, the at least one processor is configured to:
determine the first extended region of interest for the first object based on the location of the first region of interest.

26. The apparatus of claim 23, wherein, to determine the first extended region of interest for the first object, the at least one processor is configured to:
determine the first extended region of interest for the first object based on the size and the location of the first region of interest.

27. The apparatus of claim 21, wherein, to determine the first extended region of interest for the first object, the at least one processor is configured to:
determine a first depth associated with a first element of the one or more additional elements of the multi-point grid, the first element neighboring the at least one element associated with the first region of interest;
determine a difference between the first depth and a depth of the at least one element associated with the first region of interest is less than a threshold difference; and
associate the first element with the first extended region of interest based on determining the difference between the first depth and the depth of the at least one element associated with the first region of interest is less than the threshold difference.

28. The apparatus of claim 27, wherein the at least one processor is configured to associate the first element with the first extended region of interest further based on a confidence of the first depth being greater than a confidence threshold.

29. The apparatus of claim 27, wherein the at least one processor is configured to:
determine a second depth associated with a second element of the one or more additional elements of the multi-point grid, the second element neighboring the first element of the one or more additional elements;
determine a difference between the second depth and the first depth is less than the threshold difference; and
associate the second element with the first extended region of interest based on determining the difference between the second depth and the first depth is less than the threshold difference.

30. The apparatus of claim 27, wherein the at least one processor is configured to:
determine a second depth associated with a second element of the one or more additional elements of the multi-point grid, the second element neighboring the first element of the one or more additional elements;
determine the difference between the second depth and the first depth is greater than the threshold difference; and
exclude the second element from the first extended region of interest based on determining the difference between the second depth and the first depth is greater than the threshold difference.

31. The apparatus of claim 21, wherein, to determine the representative depth information representing the first distance, the at least one processor is configured to:
determining a representative depth value for the first extended region of interest based on depth values of the plurality of elements associated with the first extended region of interest.

32. The apparatus of claim 31, wherein the representative depth value includes an average of the depth values of the plurality of elements associated with the first extended region of interest.

33. The apparatus of claim 21, wherein the at least one processor is configured to:
based on the first region of interest being the only region of interest determined for the image, process the image based on the representative depth information representing the first distance.

34. The apparatus of claim 33, wherein, to process the image based on the representative depth information representing the first distance, the at least one processor is configured to perform at least one of automatic-exposure, automatic-focus, automatic-white-balance, and automatic-zoom on at least the first region of interest of the image.

35. The apparatus of claim 21, wherein the at least one processor is configured to:
determine a second region of interest corresponding to a second object depicted in the image, the second region of interest being associated with at least one additional element of the multi-point grid associated with the multi-point depth sensing system;
determine a second extended region of interest for the second object, the second extended region of interest being associated with a plurality of elements including the at least one additional element and second one or more additional elements of the multi-point grid; and
based on the plurality of elements associated with the second extended region of interest, determine representative depth information representing a second distance between the at least one camera and the second object depicted in the image.

36. The apparatus of claim 35, wherein the at least one processor is configured to:
determine combined depth information based on the representative depth information representing the first distance and the representative depth information representing the second distance.

37. The apparatus of claim 36, wherein, to determine the combined depth information, the at least one processor is configured to determine a weighted average of the representative depth information representing the first distance and the representative depth information representing the second distance.

38. The apparatus of claim 36, wherein the at least one processor is configured to:
process the image based on the combined depth information.

39. The apparatus of claim 38, wherein, to process the image based on the combined depth information, the at least one processor is configured to perform at least one of automatic-exposure, automatic-focus, automatic-white-balance, and automatic-zoom on at least the first region of interest of the image.

40. The apparatus of claim 21, wherein the multi-point depth sensing system includes a transmitter including a plurality of light sources and a receiver configured to receive reflections of light emitted by the plurality of light sources, and wherein the representative depth information is determined based on the received reflections of light.

41. (canceled)

42. (canceled)

43. A method of processing image data, the method comprising:
determining a region of interest corresponding to at least one object depicted in an image obtained using at least one camera, the region of interest being associated with a plurality of elements of a multi-point grid associated with a multi-point depth sensing system;
determining whether the region of interest includes multi-depth information based on depth information associated with the plurality of elements; and
based on whether the region of interest includes multi-depth information, determining representative depth information representing a distance between the at least one camera and the at least one object depicted in the image.

44. (canceled)

45. (canceled)

46. (canceled)

47. (canceled)

48. (canceled)

49. (canceled)

50. (canceled)

51. An apparatus for processing image data, comprising:
at least one memory; and
at least one processor coupled to the at least one memory, the at least one processor configured to:
determine a region of interest corresponding to at least one object depicted in an image obtained using at least one camera, the region of interest being associated with a plurality of elements of a multi-point grid associated with a multi-point depth sensing system;
determine whether the region of interest includes multi-depth information based on depth information associated with the plurality of elements; and
based on whether the region of interest includes multi-depth information, determine representative depth information representing a distance between the at least one camera and the at least one object depicted in the image.

52. The apparatus of claim 51, wherein the at least one processor is configured to:
sort the plurality of elements according to the representative depth information associated with the plurality of elements, wherein the plurality of elements are sorted from smallest depth to largest depth.

53. The apparatus of claim 51, wherein, to determine whether the region of interest includes the multi-depth information, the at least one processor is configured to:
determine a difference between a smallest depth value of the plurality of elements and a largest depth value of the plurality of elements is greater than a multi-depth threshold; and
determine the region of interest includes multi-depth information based on determining the difference between the smallest depth value and the largest depth value is greater than the multi-depth threshold.

54. (canceled)

55. The apparatus of claim 51, wherein, to determine whether the region of interest includes the multi-depth information, the at least one processor is configured to:
determine a difference between a smallest depth value of the plurality of elements and a largest depth value of the plurality of elements is less than a multi-depth threshold; and
determine the region of interest does not include multi-depth information based on determining the difference between the smallest depth value and the largest depth value is less than the multi-depth threshold.

56. (canceled)

57. The apparatus of claim 51, wherein the at least one processor is configured to:
process the image based on the representative depth information representing the distance, wherein processing the image includes performing at least one of automatic-exposure, automatic-focus, automatic-white-balance, and automatic-zoom on at least the region of interest of the image.

58. The apparatus of claim 51, wherein the multi-point depth sensing system includes a transmitter including a plurality of light sources and a receiver configured to receive reflections of light emitted by the plurality of light sources, and wherein the representative depth information is determined based on the received reflections of light.

59. (canceled)

60. (canceled)
